(19) United States
(12) Patent Application Publication
(10) Pub. No.: US 2022/0220722 A1
(43) Pub. Date: Jul. 14, 2022

(54) Folding Roof Component

(71) Applicant: Build IP LLC, North Las Vegas, NV (US)

(72) Inventors: Paolo Tiramani, Las Vegas, NV (US); Galiano Tiramani, Las Vegas, NV (US); Kyle Denman, North Las Vegas, NV (US)

(21) Appl. No.: 17/569,962

(22) Filed: Jan. 6, 2022

Related U.S. Application Data
(63) Continuation-in-part of application No. 17/527,520, filed on Nov. 16, 2021.
Application No. 17/527,520 is a continuation of application No. PCT/US2021/059440, filed on Nov. 16, 2021.
Application No. PCT/US2021/059440 is a continuation-in-part of application No. 17/504,883, filed on Oct. 19, 2021.
(60) Provisional application No. 63/188,101, filed on May 13, 2021.
(60) Provisional application No. 63/136,268, filed on Jan. 12, 2021.
(60) Provisional application No. 63/188,101, filed on May 13, 2021.
(60) Provisional application No. 63/136,268, filed on Jan. 12, 2021.
(60) Provisional application No. 63/196,400, filed on Jun. 3, 2021.
(60) Provisional application No. 63/181,447, filed on Apr. 29, 2021.
(60) Provisional application No. 63/136,268, filed on Jan. 12, 2021.
(60) Provisional application No. 63/196,400, filed on Jun. 3, 2021.
(60) Provisional application No. 63/188,101, filed on May 13, 2021.
(60) Provisional application No. 63/136,268, filed on Jan. 12, 2021.

(51) Int. Cl. E04B 1/344; E04B 1/343; E04C 2/292; E04B 2/00; E04B 5/02; B32B 15/18; B32B 15/20; B32B 5/18; B32B 7/12; B32B 15/04

(52) U.S. Cl. CPC E04B 1/3445; B32B 2419/00; E04B 1/34384; E04C 2/292; E04C 2/46; E04C 2/50; B32B 15/18; B32B 15/20; B32B 5/18; B32B 7/12; B32B 15/046; E04B 2001/34389; E04B 2103/04; E04B 2103/06; E04B 5/02; B32B 2266/0228; E04B 1/34321

(57) ABSTRACT

A folded building structure having a first roof portion, a second roof portion stacked on and pivotally connected to the first roof portion in a folded position, and a third roof portion stacked on and pivotally connected to the second roof portion in a folded position. The width of a transverse roof edge of the third roof portion is greater than the width of a transverse roof edge of the second roof portion and greater than the width of a transverse roof edge of the first roof portion.

### CROSS-REFERENCES TO RELATED APPLICATIONS

This application is a continuation-in-part application of U.S. Nonprovisional application Ser. No. 17/527,520, filed Nov. 16, 2021, which is a continuation application of PCT Patent Application No. PCT/US21/59440, filed Nov. 16, 2021, and which claims the benefit of U.S. Provisional Application No. 63/136,268 filed Jan. 12, 2021 and U.S. Provisional Application No. 63/188,101 filed May 13, 2021; this application is also a continuation-in-part application of U.S. Nonprovisional application Ser. No. 17/504,883, filed Oct. 19, 2021, which claims the benefit of U.S. Provisional Application No. 63/136,268 filed Jan. 12, 2021, U.S. Provisional Application No. 63/181,447, filed Apr. 29, 2021, and U.S. Provisional Application No. 63/196,400 filed Jun. 3, 2021; and this application additionally claims the benefit of U.S. Provisional Application No. 63/196,400, filed Jun. 3, 2021, U.S. Provisional Application No. 63/188,101, filed May 13, 2021, and U.S. Provisional Application No. 63/136,268 filed Jan. 12, 2021.

### BACKGROUND OF THE INVENTION

### Field of the Invention

The inventions herein relate to structures, such as dwellings and other buildings for residential occupancy, commercial occupancy and/or material storage, and to components for such structures.

### Description of the Related Art

In the field of residential housing, the traditional technique for building homes is referred to as “stick-built” construction, where a builder constructs housing at the intended location using in substantial part raw materials such as wooden boards, plywood panels, and steel columns. The materials are assembled piece by piece over a previously prepared portion of ground, for example, a poured concrete slab or a poured concrete or cinder block foundation.

There have been a variety of efforts to depart from the conventional construction techniques used to create dwellings, as well as commercial spaces and like. One of the alternatives to stick-built construction is very generally referred to as modular housing. As opposed to stick-built construction, where the structure is built on-site, a modular house is constructed in a factory and then shipped to the site, often by means of a tractor-trailer.

Such modular housing often exceeds in size normally-permitted legal limits for road transport. For example, in the United States the maximum permitted dimensions for road transport are in general 102 inches (259.1 cm) in width, 13.5 feet (4.11 m) in height and 65 to 75 feet (19.81 to 22.86 m) in length. Thus, in many cases transporting a modular house from factory to site requires oversize load permits, which may impose restrictions on when transport can be undertaken and what routes can be utilized. Oversize road regulations may also require the use of an escort car and a trailing car as well. All of these requirements and restrictions inevitably increase the cost of the modular housing.

Significant advancements in the construction of dwellings and commercial space have been made by the current inventors, as exemplified by their patent documents, including U.S. Pat. Nos. 8,474,194, 8,733,029, 10,688,906, 10,829,029 and 10,926,689. In one aspect, these patents pertain to fabricating wall, floor and roof components in a factory that are folded together into a compact shipping module, and which are then transported to the intended location and unfolded to yield a fully formed structure.

### SUMMARY OF THE INVENTION

The present inventions constitute advancements in the deployment of roof portions of folded building structures to reduce the risk of certain of the roof portions being “pinned” against other portions of the building structures during the steps of unfolding.

In one aspect, the present inventions are directed to a folded building structure comprising a fixed space portion defined by (i) a first floor portion, (ii) a rectangular planar first roof portion having a thickness, a longitudinal length, a first transverse width and an interior surface, and (iii) a planar first fixed wall portion of a first wall component, which first fixed wall portion has a first fixed portion top edge and adjoins a first transverse edge of the first floor portion and a first transverse edge of the first roof portion. There is provided a rectangular planar second roof portion having a thickness, a longitudinal length, a second transverse width and an interior surface, with the second roof portion horizontally stacked in a second roof portion folded position on the first roof portion and pivotally connected along a horizontal longitudinal first axis to the first roof portion to permit the second roof portion to pivot, about the first axis relative to the first roof portion, from the second roof portion folded position to a second roof portion unfolded position at which the first and second roof portions are coplanar; and also a rectangular planar third roof portion having a thickness, a longitudinal length, a longitudinally-oriented leading edge, a third transverse width and an interior surface, with the third transverse width being greater than the first transverse width and being greater than the second transverse width, and with the third roof portion horizontally stacked in a third roof portion folded position on the second roof portion and pivotally connected along a horizontal longitudinal second axis to the second roof portion to permit the third roof portion to pivot, about the second axis relative to the second roof portion, from the third roof portion folded position to a third roof portion unfolded position at which the third roof portion is coplanar with the second roof portion in the second roof portion unfolded position. The first wall component additionally includes a planar first pivoting wall portion with a first pivoting portion top edge having a first pivoting portion top edge length, with the first pivoting wall portion (i) disposed in a first pivoting portion folded position proximate the fixed space portion and (ii) pivotally connected along a vertical third axis to the first fixed wall portion of the first wall component to permit the first pivoting wall portion to pivot, about the third axis relative to the first fixed wall portion, from the first pivoting portion folded position to a first pivoting portion unfolded position, coplanar with the first fixed wall portion, in which the first pivoting portion top edge is positioned under the interior surfaces of the second and third roof portions when the second and third roof portions are in their unfolded positions.

In another aspect, the present inventions are directed to a folded building structure comprising a planar first roof portion having a thickness, a first longitudinal edge, a first transverse roof edge having a width, an opposed second transverse roof edge having a width, and an interior surface, with the first transverse roof edge adjoining the first longitudinal edge at a first end and the opposed second transverse roof edge adjoining the first longitudinal edge at a second end. In addition, a planar second roof portion having a thickness, a third transverse roof edge having a width, an opposed fourth transverse roof edge having a width, and an interior surface, is horizontally stacked in a second roof portion folded position on the first roof portion and pivotally connected along a horizontal longitudinal first axis to the first roof portion to permit the second roof portion to pivot, about the first axis relative to the first roof portion, from the second roof portion folded position to a second roof portion unfolded position at which the first and second roof portions are coplanar. There is additionally provided a planar third roof portion having a thickness, a longitudinally-oriented leading edge, a fifth transverse roof edge having a width, an opposed sixth transverse roof edge having a width, and a planar interior surface, which is horizontally stacked in a third roof portion folded position on the second roof portion and pivotally connected along a horizontal longitudinal second axis to the second roof portion to permit the third roof portion to pivot, about the second axis relative to the second roof portion, from the third roof portion folded position to a third roof portion unfolded position coplanar with the second roof portion in the second roof portion unfolded position. There is also provided a first wall having a first vertical edge and a first transverse top edge that adjoins the first vertical edge, the first transverse top edge having a top edge length at least equal to the sum of the widths of the first, third and fifth transverse roof edges, with the first roof portion joined to the first transverse top edge proximate to the first transverse roof edge with the first end proximate to the first vertical edge; and a second wall having a second vertical edge and a second transverse top edge that adjoins the second vertical edge, the second transverse top edge having a top edge length at least equal to the sum of the widths of the second, fourth and sixth transverse roof edges, the first roof portion joined to the second transverse top edge proximate to the second transverse roof edge with the second end proximate to the second vertical edge. The width of the fifth transverse roof edge is greater than the width of the first transverse roof edge and greater than the width of the third transverse roof edge, and the width of the sixth transverse roof edge is greater than the width of the second transverse roof edge and greater than the width of the fourth transverse roof edge.

In yet another aspect, the present inventions are directed to a folded building structure comprising a planar first roof portion having a thickness, a first longitudinal edge, a first transverse roof edge having a width, an opposed second transverse roof edge having a width, and an interior surface, with the first transverse roof edge adjoining the first longitudinal edge at a first end and the opposed second transverse roof edge adjoining the first longitudinal edge at a second end. In addition, a planar second roof portion having a thickness, a third transverse roof edge having a width, an opposed fourth transverse roof edge having a width, and an interior surface, is horizontally stacked in a second roof portion folded position on the first roof portion and pivotally connected along a horizontal longitudinal first axis to the first roof portion to permit the second roof portion to pivot, about the first axis relative to the first roof portion, from the second roof portion folded position to a second roof portion unfolded position at which the first and second roof portions are coplanar. There is additionally a planar third roof portion having a thickness, a longitudinally-oriented leading edge, a fifth transverse roof edge having a width, an opposed sixth transverse roof edge having a width, and an interior surface, which is horizontally stacked in a third roof portion folded position on the second roof portion and pivotally connected along a horizontal longitudinal second axis to the second roof portion to permit the third roof portion to pivot, about the second axis relative to the second roof portion, from the third roof portion folded position to a third roof portion unfolded position coplanar with the second roof portion in the second roof portion unfolded position. There is also provided a first wall having a first vertical edge and a first transverse top edge that adjoins the first vertical edge, the first transverse top edge having a top edge length at least equal to the sum of the widths of the first, third and fifth transverse roof edges, with the first roof portion joined to the first transverse top edge proximate to the first transverse roof edge with the first end proximate to the first vertical edge; and a second wall having a second vertical edge and a second transverse top edge that adjoins the second vertical edge, the second transverse top edge having a top edge length at least equal to the sum of the widths of the second, fourth and sixth transverse roof edges, the first roof portion joined to the first transverse top edge proximate to the second transverse roof edge with the second end proximate to the second vertical edge. A first wheel caster having a first caster length is secured proximate to the leading edge of the third roof portion at a location such that the first wheel caster comes into rolling contact with the first transverse top edge for a least a portion of the top edge length thereof when the third roof portion is moved between the third roof portion folded position and the third roof portion unfolded position; and the sum of the width of the fifth transverse roof edge and the first caster length is greater than the width of the first transverse roof edge and greater than the width of the third transverse roof edge.

These and other aspects of the present inventions are described in the drawings annexed hereto, and in the description of the preferred embodiments and claims set forth below.

### BRIEF DESCRIPTION OF THE DRAWINGS

FIG. 1 is a perspective view of a finished structure prepared in accordance with the present inventions.

FIG. 2 is a schematic top view of a finished structure prepared in accordance with the present inventions.

FIG. 3 is a schematic end view of a shipping module from which is formed the finished structure shown in FIG. 1.

FIGS. 4 and 5 are partial cutaway views of a finished structure in accordance with the present inventions, depicting in greater detail aspects of the roof and floor components.

FIG. 6 is a schematic perspective view depicting the exterior edge reinforcement for a wall component in accordance with the present inventions.

FIG. 7 is an exploded cross-sectional view of a multi-layered, laminate construction for use in the enclosure components of the present inventions.

FIGS. 8A, 8B and 8C are schematic side views showing an unfolding sequence of three roof portions having the same dimension in the transverse direction.

FIG. 9 is a schematic side view of the unfolding at a particular point in the unfolding sequence of three roof portions, with one differently dimensioned in the transverse direction, in accordance with the present inventions.

FIG. 10 is a schematic side view of the unfolding at a particular point in the unfolding sequence of three roof portions, wherein one is provided with wheel casters, in accordance with the present inventions.

### DETAILED DESCRIPTION OF THE PREFERRED EMBODIMENTS

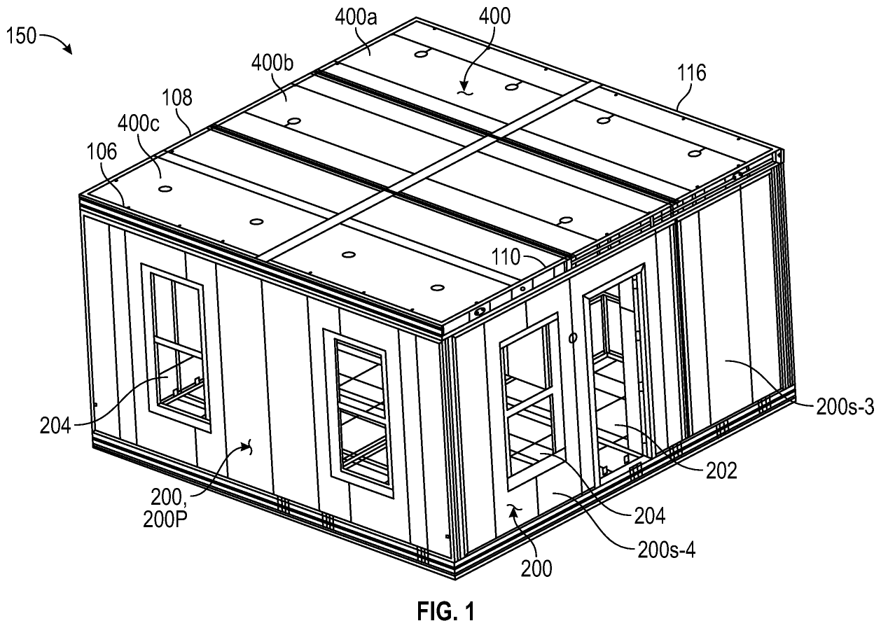

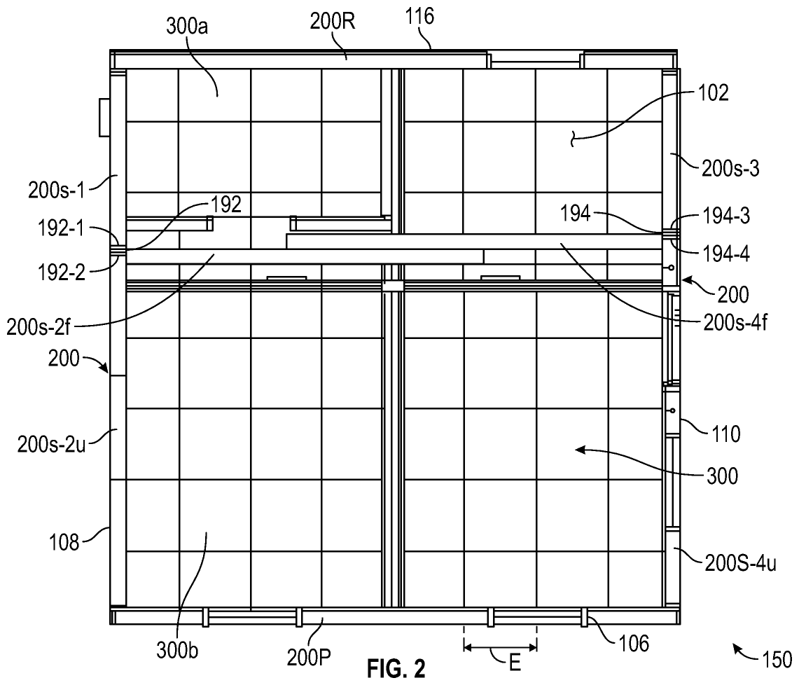

An embodiment of the foldable, transportable structure 150 in which the inventions disclosed herein can be implemented is depicted in FIGS. 1 through 5. When fully unfolded, as exemplified by FIG. 1, structure 150 has a rectangular shape made of three types of generally planar and rectangular enclosure components 155, the three types of enclosure components 155 consisting of a wall component 200, a floor component 300, and a roof component 400. As shown in FIGS. 1 and 2, the perimeter of structure 150 is defined by first longitudinal edge 106, first transverse edge 108, second longitudinal edge 116 and second transverse edge 110. For convenience, a direction parallel to first longitudinal edge 106 and second longitudinal edge 116 may be referred to as the “longitudinal” direction, a direction parallel to first transverse edge 108 and second transverse edge 110 may be referred to as the “transverse” direction, and a direction parallel to the vertical direction in FIG. 1 may be referred to as the “vertical” direction. Structure 150 as shown has one floor component 300, one roof component 400 and four wall components 200; although it should be understood that the present inventions are applicable to structures having other configurations as well.

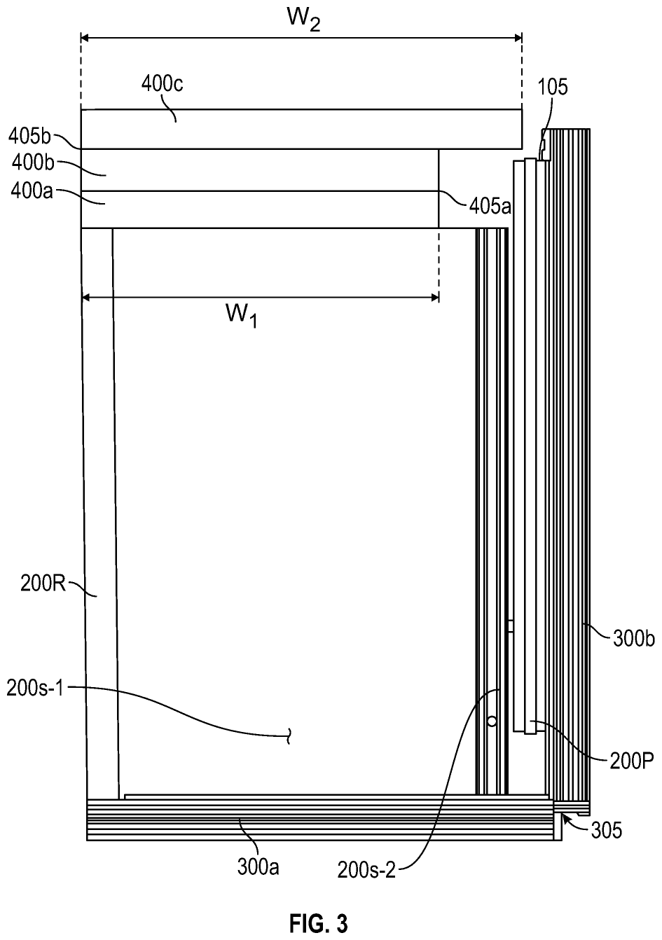

Enclosure components 155 (wall component 200, floor component 300 and roof component 400) can be fabricated and dimensioned as described herein and positioned together to form a shipping module 100, shown end-on in FIG. 3. The enclosure components 155 are dimensioned so that the shipping module 100 is within U.S. federal highway dimensional restrictions. As a result, shipping module 100 can be transported over a limited access highway more easily, and with appropriate trailering equipment, transported without the need for oversize permits. Thus, the basic components of structure 150 can be manufactured in a factory, positioned together to form the shipping module 100, and the modules 100 can be transported to the desired site for the structure, where they can be readily assembled, as described herein.

### Enclosure Component (155): General Description

The enclosure components 155 of the present invention include a number of shared design features that are described below.

A. Laminate Structure Design

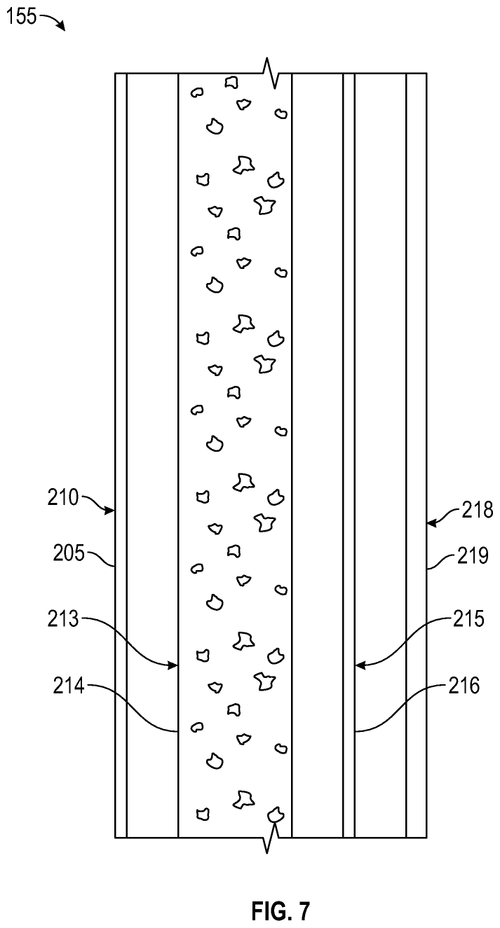

Enclosure components 155 can be fabricated using a multi-layered, laminate design. A particular laminate design that can be used to fabricate enclosure components 155 comprises a first structural layer 210, a foam panel layer 213, a second structural layer 215 and a protective layer 218, as shown in FIG. 7 and described further below.

In particular, first structural layer 210 is provided in the embodiment of enclosure component 155 that is depicted in FIG. 7. First structural layer 210 in the embodiment shown comprises a sheet metal layer 205, which can be for example galvanized steel or aluminum. Sheet metal layer 205 is made from a plurality of generally planar rectangular metal sheets 206 positioned adjacent to each other to generally cover the full area of the intended enclosure component 155.

Referring again to FIG. 7, there is next provided in the depicted embodiment of enclosure component 155 a foam panel layer 213, comprising a plurality of generally planar rectangular foam panels 214 collectively presenting a first face 211 and a second opposing face 212. Foam panels 214 are made for example of expanded polystyrene (EPS) foam. A number of these foam panels 214 are positioned adjacent to each other and superposed first face-down on first structural layer 210 to generally cover the full area of the intended enclosure component 155. The foam panels 214 of foam panel layer 213 preferably are fastened to the metal sheets 206 of first structural layer 210 using a suitable adhesive, preferably a polyurethane based construction adhesive. Foam panel layer 213 can include exterior edge reinforcement and interior edge reinforcement, as described further below

In the embodiment of the enclosure component 155 depicted in FIG. 7, there is next provided a second structural layer 215, having a first face that is positioned on the second opposing face 212 of foam panels 214 (the face distal from first structural layer 210), and also having a second opposing face. Second structural layer 215 in the embodiment shown comprises a sheet metal layer 216, which can be for example galvanized steel or aluminum. Sheet metal layer 216 is made from a plurality of generally planar rectangular metal sheets 217 positioned adjacent to each other and superposed first face-down on the second opposing face of foam panel layer 213 to generally cover the full area of the intended enclosure component 155. The metal sheets 217 of second structural layer 215 preferably are fastened to foam panel layer 213 using a suitable adhesive, preferably a polyurethane based construction adhesive.

In the embodiment of the enclosure component 155 depicted in FIG. 7, there is optionally next provided a protective layer 218, having a first face that is positioned on the second opposing face of second structural layer 215 (the face distal from foam panel layer 213), and also having a second opposing face. Optional protective layer 218 in the embodiment shown comprises a plurality of rectangular structural building panels 219 principally comprising an inorganic composition of relatively high strength, such as magnesium oxide (MgO). The structural building panels 219 are positioned adjacent to each other and superposed first face-down on the second opposing face of second structural layer 215 to generally cover the full area of the intended enclosure component 155. The building panels 219 of protective layer 218 preferably are fastened to second structural layer 215 using a suitable adhesive, preferably a polyurethane based construction adhesive. Protective layer 218 can be used if desired to impart a degree of fire resistance to the enclosure component 155, as well as to provide a pleasing texture and/or feel.

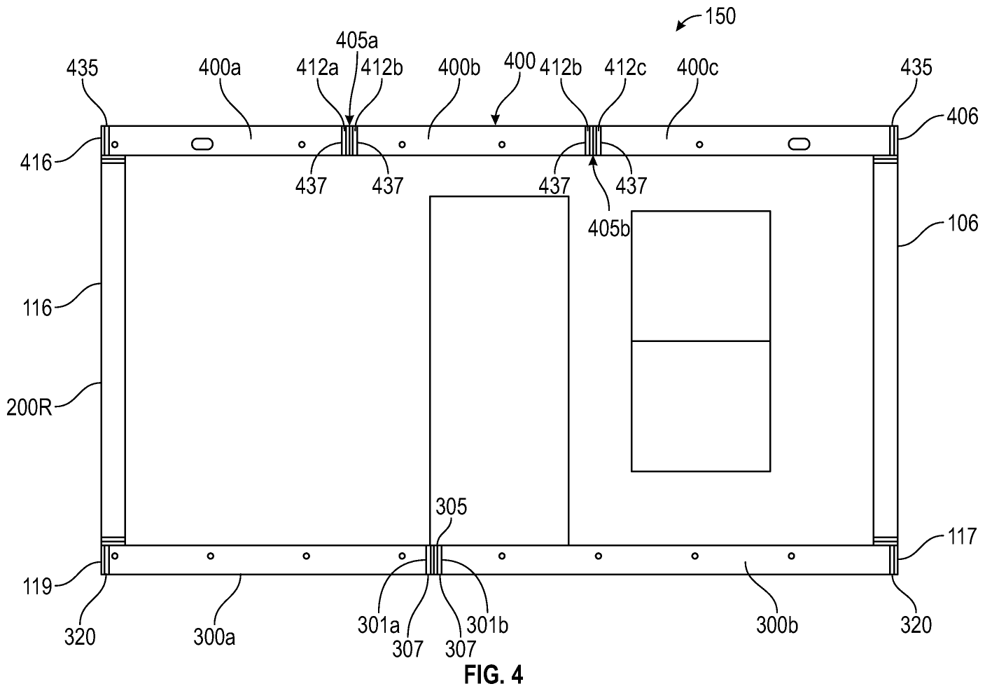

Other embodiments of multi-layered, laminate designs, which can be used to fabricate the enclosure components 155 of the present invention, are described in U.S. Nonprovisional patent application Ser. No. 16/786,130, entitled “Foldable Building Structures with Utility Channels and Laminate Enclosures,” having the same inventors as this disclosure, filed on Feb. 10, 2020 and now issued as U.S. Pat. No. 11,118,344. The contents of that U.S. Nonprovisional patent application Ser. No. 16/786,130, entitled “Foldable Building Structures with Utility Channels and Laminate Enclosures,” having the same inventors as this disclosure and filed on Feb. 10, 2020, are incorporated by reference as if fully set forth herein, particularly including the multi-layered, laminate designs described for example at 91910034-57 and depicted in FIGS. 4A-4D thereof.

B. Enclosure Component Exterior Edge Reinforcement

The exterior edges of each enclosure component 155 (i.e., the edges that define the perimeter of enclosure component 155) can be provided with exterior edge reinforcement, as desired. Exterior edge reinforcement generally comprises an elongate rigid member which can protect the foam panel material of foam panel layer 213 that would otherwise be exposed at the exterior edges of enclosure components 155. Exterior edge reinforcement can be fabricated from one or more of laminated strand lumber board, wooden board, C-channel extruded aluminum or steel, or the like, and is generally secured to the exterior edges of enclosure component 155 with fasteners, such as screw or nail fasteners, and/or adhesive.

C. Enclosure Component Partitioning

Enclosure components 155 in certain instances are partitioned into enclosure component portions to facilitate forming a compact shipping module 100. In those instances where an enclosure component 155 is partitioned into enclosure component portions, any exterior edge reinforcement on the exterior edges defining the perimeter of the enclosure component is segmented as necessary between or among the portions.

The enclosure component portions can be joined by hinge structures or mechanisms to permit the enclosure component portions to be “folded” and thereby contribute to forming a compact shipping module 100.

D. Enclosure Component Interior Edge Reinforcement

An enclosure component 155 partitioned into enclosure component portions will have interior edges. There will be two adjacent interior edges for each adjacent pair of enclosure component portions. Such interior edges can be provided with interior edge reinforcement. Similar to exterior edge reinforcement, such interior edge reinforcement generally comprises an elongate, rigid member which can protect the foam panel material of foam panel layer 213 which that would otherwise be exposed at the interior edges of enclosure components 155. Interior edge reinforcement can be fabricated from one or more of laminated strand lumber board, wooden board, C-channel extruded aluminum or steel, or the like, and is generally secured to the interior edges of enclosure component 155 with fasteners, such as screw or nail fasteners, and/or adhesive.

E. Enclosure Component Load Transfer

In the case of enclosure components 155, it is necessary to transfer the loads imposed on their surfaces to their exterior edges, where those loads can be transferred either to or through adjoining walls, or to the building foundation. For enclosure components 155 that are horizontally oriented when in use (floor component 300 and roof component 400), such loads include the weight of equipment, furniture and people borne by their surfaces, as well as vertical seismic loads. For enclosure components that are vertically oriented when in use (wall component 200), such loads include those arising from meteorological conditions (hurricanes, tornadoes, etc.) and human action (vehicle and other object impacts).

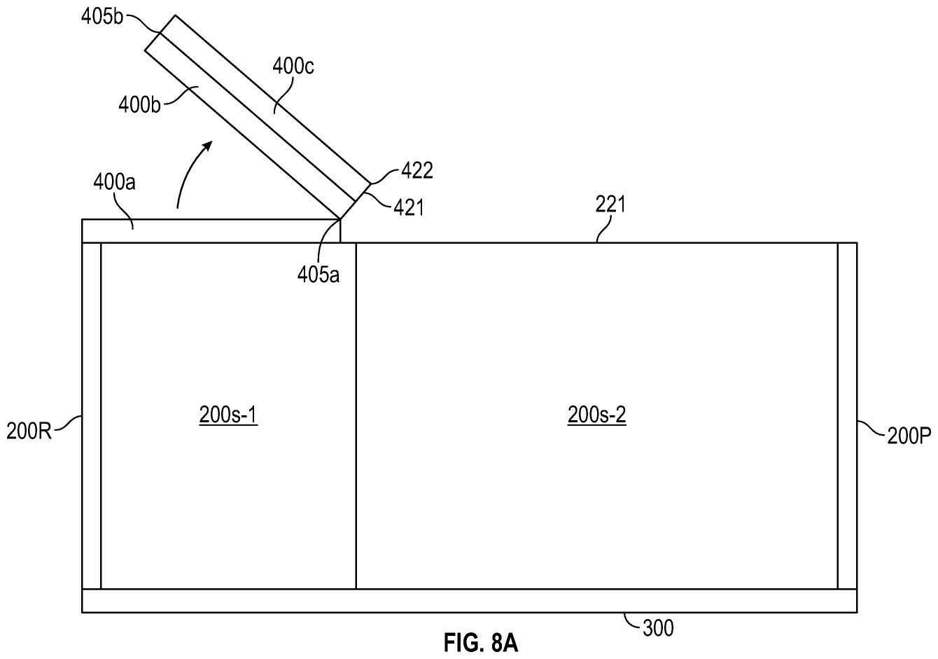

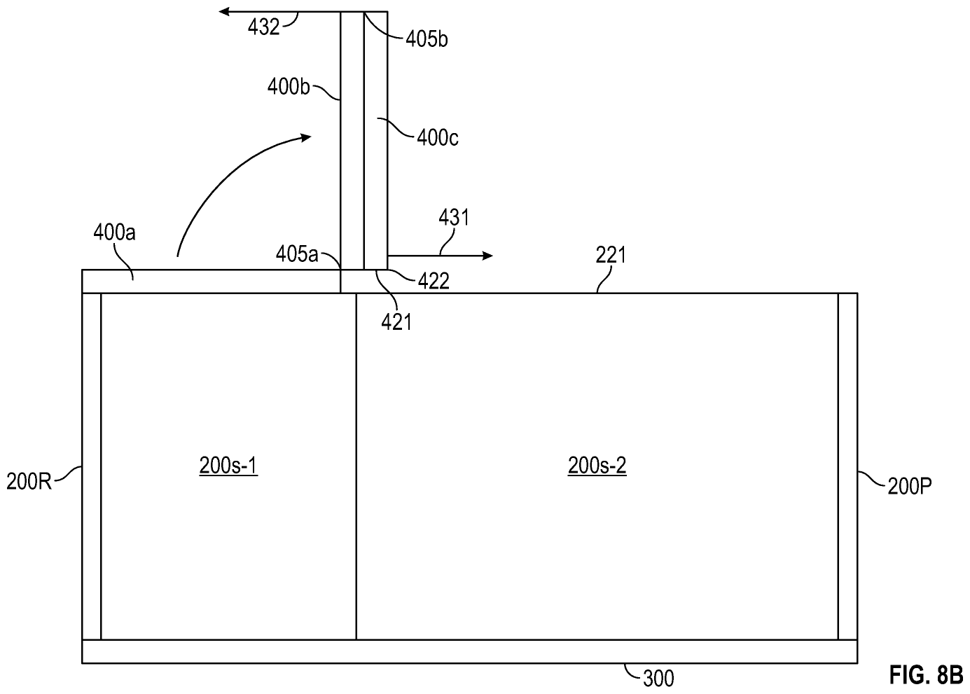

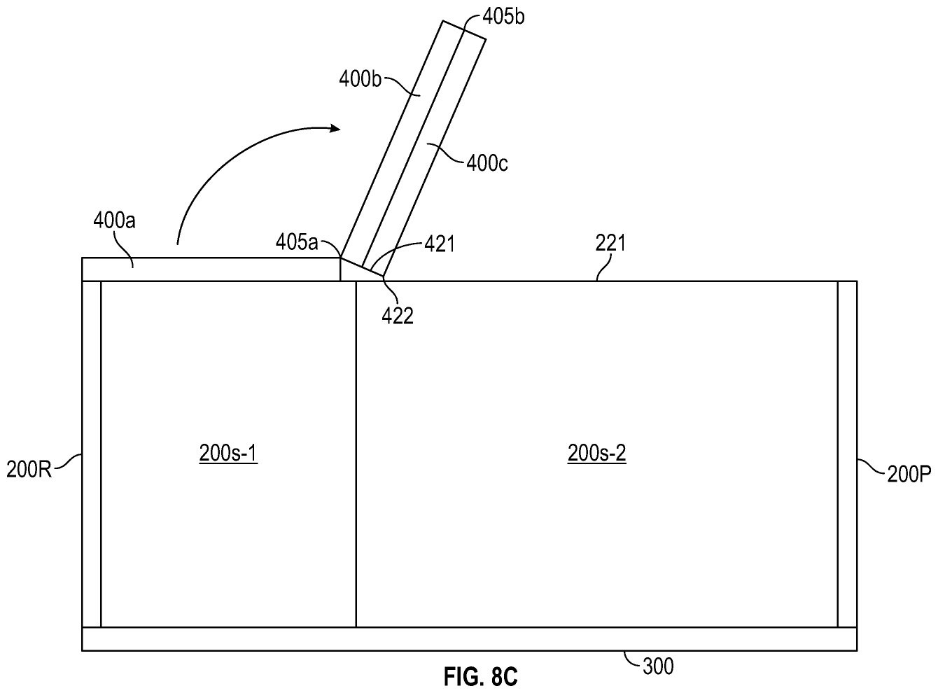

For this purpose, multi-layered, laminate designs as shown in FIG. 7 will function to transfer the loads described above. To add additional load transfer capability, structural members, such as beams and/or joists, can be utilized within the perimeter of the enclosure components 155, as is deemed appropriate to the specific design of structure 150 and the particular enclosure component 155, to assist in the transfer of loads to the exterior edges. Particular embodiments of such structural members, which also incorporate hinge structures, are described in in U.S. Nonprovisional patent application Ser. No. 17/527,520 entitled “Folding Beam Systems”, filed Nov. 16, 2021 and having the same inventors as this disclosure. The contents of that U.S. Nonprovisional patent application Ser. No. 17/527,520 entitled “Folding Beam Systems”, filed Nov. 16, 2021 and having the same inventors as this disclosure, is incorporated by reference as if fully set forth herein, particularly the description of the hinged vertical load transfer components set forth for example in [symbol] 0074-0089 and 0104-0126 and in FIGS. 8A-13E and 15A-24A thereof, as well as the description of the associated end hinge assemblies set forth for example in [symbol] 0090-0093 and 0127-0132 and in FIGS. 14A-14B, 24B and 25A-25D thereof.

F. Enclosure Component Sealing Systems

Structure 150 comprises a number of wall, floor and roof components with abutting or exposed exterior edges, as well as a number of partitioned wall, floor and roof components with interior edges. In this regard, sealing structures can be utilized, with the objective to limit or prevent the ingress of rain water, noise and outside air across these exterior and interior edges into the interior of structure 150.

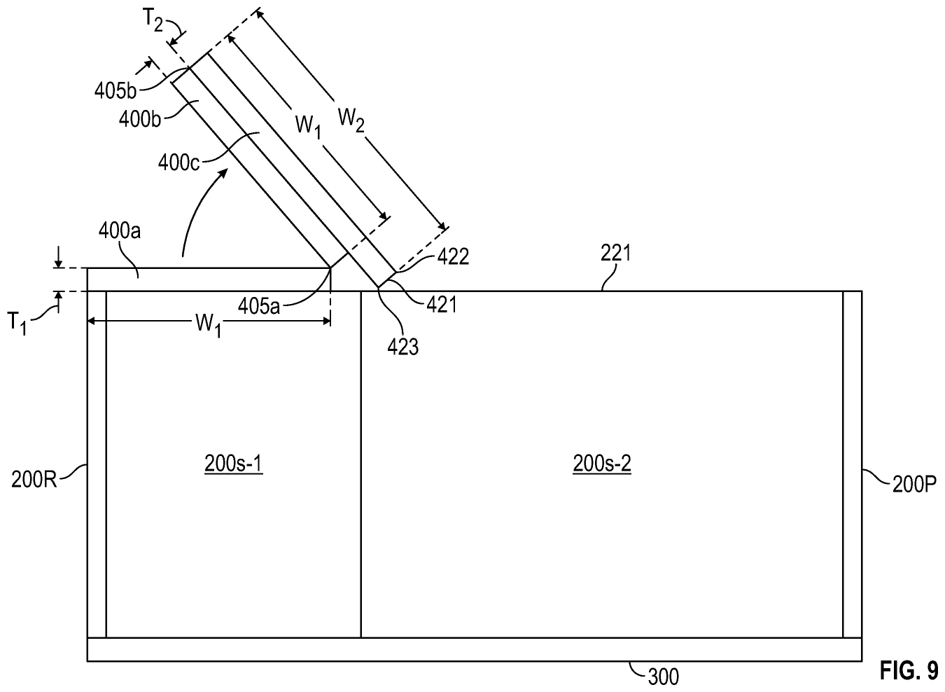

Particular sealing structures for accomplishing the foregoing objective are described in PCT Patent Application No. PCT/US21/56415, entitled “Enclosure Component Sealing Systems,” filed on Oct. 25, 2021 and having the same inventors as the present application. The contents of that PCT Patent Application No. PCT/US21/56415, entitled “Enclosure Component Sealing Systems,” filed on Oct. 25, 2021 and having the same inventors as this disclosure, are incorporated by reference as if fully set forth herein, particularly including the sealing systems described for example at [symbol] 0080-0167 and depicted in FIGS. 9-20 thereof, and also including the exemplary placements for such sealing systems described in [symbol] 0168-0174 and depicted in FIGS. 8A-8B thereof.

Further design details of wall component 200, floor component 300, and roof component 400 are provided in the sections following.

### Wall Component (200)

Typically, a structure 150 will utilize four wall components 200, with each wall component 200 corresponding to an entire wall of structure 150.

A. General Description

Wall component 200 has a generally rectangular perimeter. As shown in FIG. 1, wall components 200 have plural apertures, specifically a door aperture 202, which has a door frame and door assembly, and plural window apertures 204, each of which has a window frame and a window assembly. The height and length of wall components 200 can vary in accordance with design preference, subject as desired to the dimensional restrictions applicable to transport, described above. In this disclosure, structure 150 is fashioned with all sides of equal length; accordingly, its first and second longitudinal edges 106 and 116, and its first and second transverse edges 108 and 110, are all of equal length. It should be understood however, that the inventions described herein are applicable to structures having other dimensions, such as where two opposing wall components 200 are longer than the other two opposing wall components 200.

As indicated above, wall components 200 of the present inventions can utilize a multi-layered, laminate design. In the embodiment depicted in FIGS. 1 through 6, wall component 200 utilizes the multi-layered, laminate design shown in FIG. 7 employing these particular elements: the sheet metal layer 205 of first structural layer 210 is 24 gauge galvanized steel approximately 0.022-0.028 inch thick, the foam panels 214 of foam panel layer 213 are EPS foam approximately 5.68 inches thick, the sheet metal layer 216 of second structural layer 215 is 24 gauge galvanized steel approximately 0.022-0.028 inch thick, and the building panels 219 of protective layer 218 are MgO board approximately 0.25 inch (6 mm) thick.

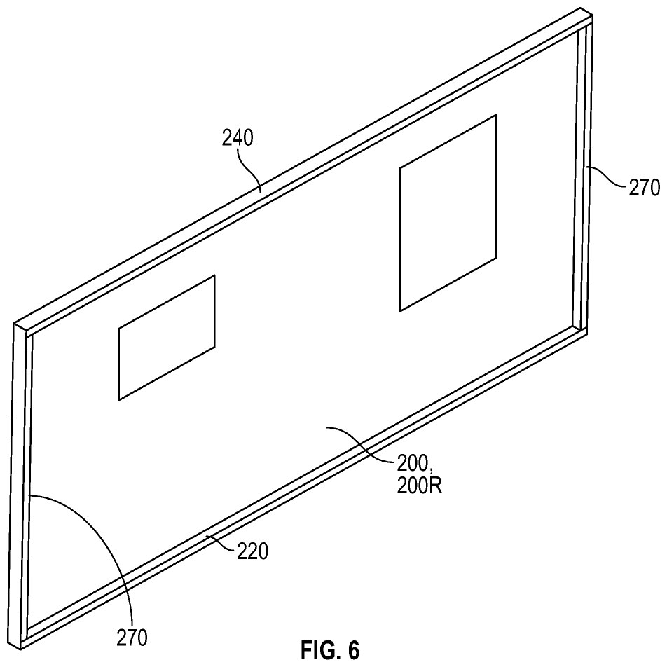

The perimeter of each wall component 200 is generally provided with exterior edge reinforcement. As exemplified by wall component 200 shown in FIG. 6, the exterior edge reinforcement for wall component 200 is a floor plate 220 along the bottom horizontal edge, a ceiling plate 240 along the top horizontal edge and two end pieces 270 respectively fastened at each vertical edge of wall component 200. In the case of a wall component 200, exterior edge reinforcement provides regions for fastening like regions of abutting wall components 200, roof component 400 and floor component 300, in addition to protecting the exterior edges of foam panel material. In the embodiment shown in FIGS. 1 through 6, the exterior edge reinforcement for wall component 200 provided by floor plate 220, ceiling plate 240, and end pieces 270 is fabricated from laminated strand lumber board 5.625″ deep and 1.5″ thick.

B. Partitioned Wall Components

Referring to FIG. 2, structure 150 has two opposing wall components 200, where one of the two opposing wall components 200 comprises first wall portion 200s-1 and second wall portion 200s-2, and the other of the two opposing wall components 200 comprises third wall portion 200s-3 and fourth wall portion 200s-4. Each of wall portions 200s-1, 200s-2, 200s-3 and 200s-4 has a generally rectangular planar configuration. As shown in FIG. 2, the interior vertical edge 192-1 of wall portion 200s-1 is proximate to a respective interior vertical edge 192-2 of wall portion 200s-2, and the interior vertical edge 194-3 of wall portion 200s-3 is proximate a respective interior vertical wall edge 194-4 of wall portion 200s-4. Interior edge reinforcement can be provided at any one or more of vertical edges 192-1, 192-2, 194-3 and 194-4. In the embodiment shown in FIGS. 1 through 6, the interior edge reinforcement provided at vertical edges 192-1, 192-2, 194-3 and 194-4, is fabricated from laminated strand lumber board 5.625″ deep and 1.5″ thick.

Referring again to FIG. 2, first wall portion 200s-1 is fixed in position on floor portion 300a proximate to first transverse edge 108, and third wall portion 200s-3 is fixed in position on floor portion 300a, opposite first wall portion 200s-1 and proximate to second transverse edge 110. First wall portion 200s-1 is joined to second wall portion 200s-2 with a hinge structure that permits wall portion 200s-2 to pivot about vertical axis 192 between a folded position and an unfolded position, and third wall portion 200s-3 is joined to fourth wall portion 200s-4 with a hinge structure to permit fourth wall portion 200s-4 to pivot about vertical axis 194 between a folded position and an unfolded position.

Notably, first wall portion 200s-1 is longer than third wall portion 200s-3 by a distance approximately equal to the thickness of wall component 200, and second wall portion 200s-2 is shorter than fourth wall portion 200s-4 by a distance approximately equal to the thickness of wall component 200. Furthermore, wall portion 200s-1 and wall portion 200s-3 are each shorter in length (the dimension in the transverse direction) than the dimension of floor portion 300a in the transverse direction. Dimensioning the lengths of wall portions 200s-1, 200s-2, 200s-3 and 200s-4 in this manner permits wall portions 200s-2 and 200s-4 to nest against each other in an overlapping relationship when in an inwardly folded position. In this regard, FIG. 2 depicts wall portions 200s-2 and 200s-4 both in their unfolded positions, where they are labelled 200s-2u and 200s4-u respectively, and FIG. 2 also depicts wall portions 200s-2 and 200s-4 both in their inwardly folded positions, where they are labelled 200s-2f and 200s4-f respectively. When wall portions 200s-2 and 200s-4 are in their inwardly folded positions (200s-2f and 200s-4f), they facilitate forming a compact shipping module. When wall portion 200s-2 is in its unfolded position (200s-2u), it forms with wall portion 200s-1 a wall component 200 proximate first transverse edge 108, and when wall portion 200s-4 is in its unfolded position (200s-4u), it forms with wall portion 200s-3 a wall component 200 proximate second transverse edge 110.

The hinge structures referenced above, for securing first wall portion 200s-1 to second wall portion 200s-2, and third wall portion 200s-3 to fourth wall portion 200s-4, can be surface mounted or recessed, and of a temporary or permanent nature. The provision of interior edge reinforcement, as described above, can provide a region for securing such hinge structures. Suitable hinge structures can be fabricated for example of ferrous or non-ferrous metal, plastic or leather material.

C. Unpartitioned Wall Components

As compared to the two wall components 200 proximate first and second transverse edges 108 and 110, which are partitioned into wall portions, the remaining two wall components 200 proximate first and second longitudinal edges 106 and 116 do not comprise plural wall portions, but rather each is a single piece structure. However, one of these wall components 200, which is sometimes denominated 200P in this disclosure, and which is located on floor portion 300b proximate first longitudinal edge 106, is pivotally secured to floor portion 300b by means of hinge structures to permit wall component 200P to pivot about horizontal axis 105 shown in FIG. 3 from a folded position to an unfolded position. Pivotally securing wall component 200P also facilitates forming a compact shipping module 100. The remaining wall component 200, sometimes denominated 200R in this disclosure, is rigidly secured on floor portion 300a proximate second longitudinal edge 116 and abutting the vertical edges of first wall portion 200s-1 and third wall portion 200s-3 proximate to second longitudinal edge 116, as shown in FIG. 2.

The hinge structures referenced above, for securing wall component 200P to floor portion 300b, can be surface mounted or recessed, and of a temporary or permanent nature. The provision of exterior edge reinforcement, as described above, can provide a region for securing such hinge structures. Suitable hinge structures can be fabricated for example of ferrous or non-ferrous metal, plastic or leather material.

### Floor Component (300)

Typically, a structure 150 will utilize one floor component 300; thus floor component 300 generally is the full floor of structure 150.

A. General Description

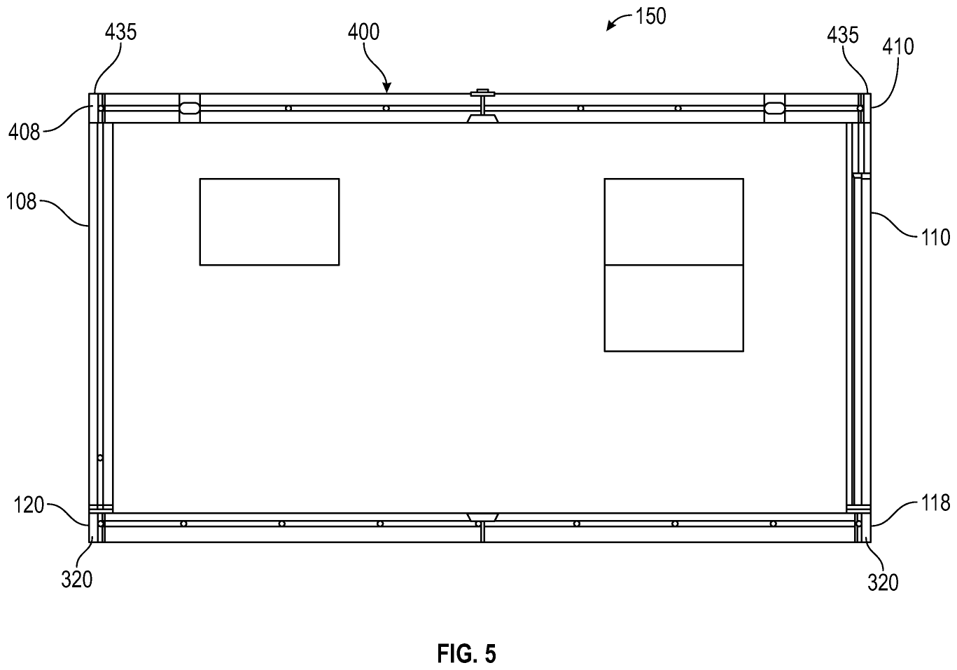

Floor component 300 has a generally rectangular perimeter. FIGS. 4 and 5 depict edge-on views of floor component 300 in accordance with the present inventions. The perimeter of floor component 300 is defined by first longitudinal floor edge 117, first transverse floor edge 120, second longitudinal floor edge 119 and second transverse floor edge 118. In particular, (a) first longitudinal floor edge 117, (b) first transverse floor edge 120, (c) second longitudinal floor edge 119 and (d) second transverse floor edge 118 generally coincide with (i.e., underlie) (w) first longitudinal edge 106, (x) first transverse edge 108, (y) second longitudinal edge 116 and (z) second transverse edge 110, respectively, of structure 150.

The length and width of floor component 300 can vary in accordance with design preference. In the particular embodiment of structure 150 depicted in FIGS. 2, 4 and 5, floor component 300 is approximately 19 feet (5.79 m) by 19 feet (5.79 m).

Floor component 300 and its constituent elements are generally designed and dimensioned in thickness and in other respects to accommodate the particular loads to which floor component 300 may be subject. It is preferred that floor component 300 utilize a multi-layered, laminate design, such as that described in connection with FIG. 7. In the embodiment shown in FIGS. 4 and 5, the bottom-most surface of floor component 300 comprises sheet metal layer 205 of first structural layer 210, with sheet metal layer 205 being 24 gauge galvanized steel approximately 0.022-0.028 inch thick. Above sheet metal layer 205 there are provided foam panels 214 of foam panel layer 213. In the embodiment shown in FIGS. 4 and 5, foam panels 214 are EPS foam approximately 7.125 inches thick. Above foam panel layer 213 there is provided sheet metal layer 216 of second structural layer 215, with sheet metal layer 216 being 24 gauge galvanized steel approximately 0.022-0.028 inch thick. Above sheet metal layer 216 of second structural layer 215, there are provided building panels 219 of protective layer 218, with building panels 219 being MgO board approximately 0.25 inch (6 mm) thick.

The perimeter of each floor component 300 is generally provided with exterior edge reinforcement. As exterior edge reinforcement for the embodiments of floor component 300 shown in FIGS. 4 and 5, a first footing beam 320 (visible edge-on in FIG. 4) is positioned at the first longitudinal floor edge 117 of floor component 300, a second footing beam 320 (visible edge-on in FIG. 5) is positioned at the second transverse floor edge 118 of floor component 300, a third footing beam 320 (visible edge-on in FIG. 5) is positioned at the first transverse floor edge 120 of floor component 300, and a fourth footing beam 320 (visible edge-on in FIG. 4) is positioned at the second longitudinal floor edge 119 of floor component 300. In the case of floor component 300, the exterior edge reinforcement provided by footing beams 320 assists in resisting vertical loads and transferring such loads to any roof component 400 thereunder and then to underlying wall components 200, and/or to the foundation of the finished structure 150, in addition to protecting the edges of foam panel material of the foam panel layer 213. In the embodiment shown in FIGS. 1 through 6, the exterior edge reinforcement provided by footing beams 420 of floor component 300 is fabricated from laminated strand lumber board 7.125″ deep and 1.5″ thick.

B. Floor Partitioning

The floor component 300 is partitioned into floor portion 300a and floor portion 300b. FIG. 2 shows flow portions 300a and 300b in plan view, and FIG. 4 shows floor portions 300a and 300b in section view, edge-on.

Each of the floor portions 300a and 300b is a planar generally rectangular structure, with floor portion 300a adjoining floor portion 300b. Interior edge 301a of floor portion 300a abuts interior edge 301b of floor portion 300b, as shown in FIG. 4. As interior edge reinforcement, a reinforcing board 307 is positioned in floor portion 300a adjacent interior edge 301a, and a reinforcing board 307 is positioned in floor portion 300b adjacent interior edge 301b. In the embodiment shown in FIGS. 1 through 5, the interior edge reinforcement provided by reinforcing boards 307 is laminated strand lumber board 7.125″ deep and 1.5″ thick.

Referring to structure 150 shown in FIGS. 2 and 4, floor portion 300a is fixed in position relative to first wall portion 200s-1, third wall portion 200s-3 and wall component 200R. Floor portion 300a is joined with hinge structures to floor portion 300b, so as to permit floor portion 300b to pivot through approximately ninety degrees (90°) of arc about a horizontal axis 305, located proximate the top surface of floor component 300, between a fully folded position, where floor portion 300b is vertically oriented as shown in FIG. 3, and a fully unfolded position, shown in FIGS. 2 and 4, where floor portion 300b is horizontally oriented and co-planar with floor portion 300a.

### Roof Component (400)

Typically, a structure 150 will utilize one roof component 400; thus roof component 400 generally is the full roof of structure 150.

A. General Description

Roof component 400 has a generally rectangular perimeter. FIGS. 1, 4 and 5 depict roof component 400 in accordance with the present inventions. The perimeter of roof component 400 is defined by first longitudinal roof edge 406, first transverse roof edge 408, second longitudinal roof edge 416 and second transverse roof edge 410. In particular, (a) first longitudinal roof edge 406, (b) first transverse roof edge 408, (c) second longitudinal roof edge 416 and (d) second transverse roof edge 410 of roof component 400 generally coincide with (i.e., overlie) (w) first longitudinal edge 106, (x) first transverse edge 108, (y) second longitudinal edge 116 and (z) second transverse edge 110, respectively, of structure 150.

The length and width of roof component 400 can vary in accordance with design preference. In the particular embodiment of structure 150 depicted in FIGS. 1, 4 and 5, the length and width of roof component 400 approximates the length and width of floor component 300.

Roof component 400 and its constituent elements are generally designed and dimensioned in thickness and in other respects to accommodate the particular loads to which roof component 400 may be subject. It is preferred that roof component 400 utilize a multi-layered, laminate design, such as that described in connection with FIG. 7. In the embodiment shown in FIGS. 4 and 5, the top-most surface of roof component 400 comprises sheet metal layer 205 of first structural layer 210, with sheet metal layer 205 being 24 gauge galvanized steel approximately 0.022-0.028 inch thick. Below sheet metal layer 205 there are provided foam panels 214 of foam panel layer 213, with foam panels 214 in the embodiment shown in FIGS. 4 and 5 being EPS foam for example approximately 7.125 inches thick. Below foam panel layer 213 there is provided sheet metal layer 216 of second structural layer 215, with sheet metal layer 216 being 24 gauge galvanized steel approximately 0.022-0.028 inch thick. Below sheet metal layer 216 of second structural layer 215, there are provided building panels 219 of protective layer 218, with building panels 219 being MgO board approximately 0.25 inch (6 mm) thick.

The perimeter of roof component 400 is generally provided with exterior edge reinforcement. As exterior edge reinforcement for the embodiment of roof component 400 shown in FIGS. 4 and 5, a first shoulder beam 435 (visible edge-on in FIG. 4) is positioned at the first longitudinal roof edge 406 of roof component 400, a second shoulder beam 435 (visible edge-on in FIG. 5) is positioned at the first transverse roof edge 408 of roof component 400, a third shoulder beam 435 (visible edge-on in FIG. 5) is positioned at the second transverse roof edge 410 of roof component 400, and a fourth shoulder beam 435 (visible edge-on in FIG. 4) is positioned at the second longitudinal roof edge 416 of roof component 400. In addition to protecting the exterior edges of foam panel material, the exterior edge reinforcement provided by shoulder beams 435 assists in resisting vertical loads and transferring such loads to lower floors through underlying wall components 200 supporting roof component 400, and then to the foundation of the finished structure 150. Such exterior edge reinforcement can also provide a region for fastening like regions of abutting enclosure components 155 (underlying and any overlying). Shoulder beams 435 of roof component 400 can be fabricated from laminated strand lumber board 7.125″ deep and 1.5″ thick.

B. Roof Partitioning

The roof component 400 of structure 150 is partitioned into roof portions 400a, 400b and 400c. FIG. 1 shows roof portions 400a, 400b and 400c in perspective view, and FIG. 4 shows roof portions 400a, 400b and 400c in section view, edge-on.

Each of the roof portions 400a, 400b and 400c is a planar generally rectangular structure, with roof portion 400a adjoining roof portion 400b, and roof portion 400b adjoining roof portion 400c. Interior edge 412c of roof component 400c abuts a first interior edge 412b of roof component 400b, as shown in FIG. 4. For interior edge reinforcement, a reinforcing board 437 is positioned adjacent interior edge 412c, and a reinforcing board 437 is positioned against first interior edge 412b. Interior edge 412a of roof portion 400a abuts a second interior edge 412b of roof portion 400b, as shown in FIG. 4. For interior edge reinforcement, a reinforcing board 437 is positioned adjacent interior edge 412a, and a reinforcing board 437 is positioned against second interior edge 412b. In the embodiment shown in FIGS. 1 through 6, the interior edge reinforcement provided by reinforcing boards 437 of roof component 400 is laminated strand lumber board 7.125″ deep and 1.5″ thick.

In the shipping module 100 shown in FIG. 3, roof portions 400a, 400b and 400c preferably are accordion folded (stacked), with roof component 400b stacked on top of roof component 400a, and roof component 400c stacked on top of the roof component 400b. Referring to structure 150 shown in FIG. 4, roof portion 400a is fixed in position relative to first wall portion 200s-1, third wall portion 200s-3 and wall component 200R. Thus to realize the accordion folded configuration shown in FIG. 3 roof portion 400a is joined to roof portion 400b with hinge structures provided between interior edge 412a of roof portion 400a and second interior edge 412b of roof portion 400b. Such hinge structures are adapted to permit roof portion 400b to pivot through up to one hundred and eighty degrees (180°) of arc about a horizontal axis 405a, located proximate the top of roof component 400 and shown in FIG. 4, between the roof fully folded position shown in FIG. 3, where roof portion 400b lies stacked flat against roof portion 400a, and the fully unfolded position shown in FIG. 4. In turn, roof portion 400b is joined to roof portion 400c with hinge structures provided between first interior edge 412b of roof portion 400b and interior edge 412c of roof portion 400c. Such hinge structures are adapted to permit roof portion 400c to pivot through up to one hundred and eighty degrees (180°) of arc about a horizontal axis 405b, located proximate the bottom of roof component 400 and shown in FIG. 4, between the folded position shown in FIG. 3, where roof portion 400c lies stacked flat against roof portion 400b (when roof portion 400b is positioned to lie flat against roof portion 400a), and the fully unfolded position shown in FIG. 4.

C. Roof Portion Dimensioning

Roof portions 400b, 400c each can be identically dimensioned in the transverse direction. When so dimensioned however, there is a risk that roof portion 400c will be impeded from deploying during the unfolding process. In particular, as roof portions 400b, 400c are unfolded from the folded stacked position (shown in FIG. 3) through the inclined orientation (shown in FIG. 8A), the weight of roof portion 400c will cause roof portion 400c to remain resting against roof portion 400b, up to the vertical orientation (shown in FIG. 8B), particularly if the unfolding force is being applied to roof portion 400b. Therefore, at approximately the vertical position shown in FIG. 8B, further unfolding preferably is undertaken by applying a horizontal force 431 to roof portion 400c in the transverse direction shown in FIG. 8B, typically applied proximate to leading edge 421 of roof portion 400c, coupled with applying a retarding horizontal force 432 to roof portion 400b in the transverse direction shown in FIG. 8B, typically at horizontal axis 405b or to roof portion 400b below horizontal axis 405b. These horizontal forces cause roof portion 400c to rotate away and separate from roof portion 400b, and thereby permit unfolding to continue. Otherwise, as unfolding proceeds there is a risk that the weight of roof portion 400c acting downwardly will “pin” the upper portion 422 of leading edge 421 against the top edges 221 of transversely-oriented wall components 200 (namely, against the segment of top edge 221 of wall portion 200s-2 shown in FIG. 8C, and against the corresponding opposing segment of top edge 221 of wall portion 200s-4), as shown in FIG. 8C, with the potential to impede unfolding and even cause damage to either or both of roof portion 400c and transversely-oriented wall components 200.

To reduce the foregoing risk, roof portion 400c can be appropriately dimensioned so that the width of roof portion 400c in the transverse direction is greater than the width in the transverse direction of either of roof portion 400a and roof portion 400b. An example of this is shown in FIG. 9. As can be seen in that figure, by increasing the transverse width W₂ of roof portion 400c an appropriate amount, the leading edge 421 of roof portion 400c will come into contact with the top edges 221 of transversely-oriented wall components 200 before roof portions 400b, 400c are vertically-oriented. In that circumstance, further efforts to rotate the roof portions 400b, 400c about horizontal axis 405a tend to beneficially act to separate roof portions 400b and 400c and reduce the risk of the leading edge 421 of roof portion 400c being pinned against the top edges 221 of transversely-oriented wall components 200.

In the case where roof portions 400a and 400b have the same transverse width W₁, the transverse width W₂ of roof portion 400c can be greater than the transverse width W₁ for example, by ten to fifteen percent, depending upon the thicknesses of roof components 400b, 400c. Alternatively, the transverse width W₂ of roof portion 400c can be greater than the transverse width W₁ of roof portions 400a and 400b by an amount sufficient such that the leading edge 421 of roof portion 400c, and particularly lower portion 423 thereof, comes into contact with the top edges 221 of transversely-oriented wall components 200 when roof portions 400b and 400c are acutely oriented during unfolding relative to roof portion 400a; i.e., before roof portions 400b, 400c are vertically-oriented during unfolding. As a further alternative, the transverse width W₂ of roof portion 400c can be greater than the transverse width W₁ of each of roof portions 400a and 400b by an amount equal to or greater than the aggregate thickness (T₁+T₂ in FIG. 9) of roof components 400a and 400b.

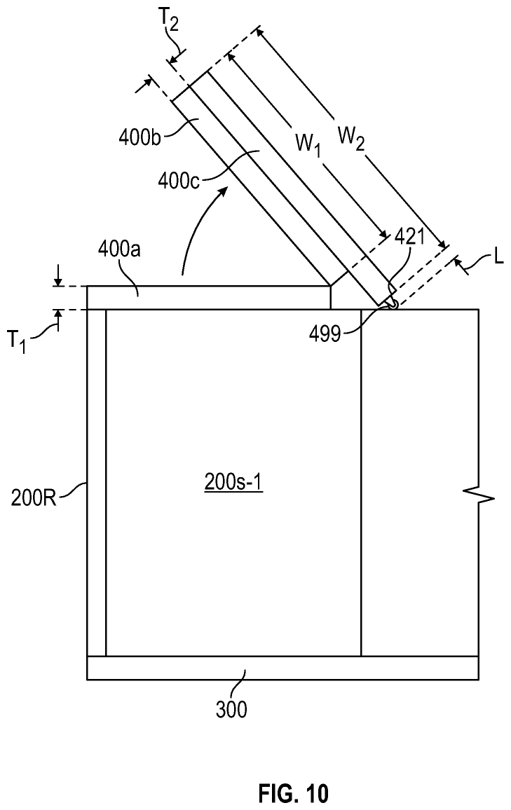

In addition, friction-reducing components can be used to facilitate unfolding roof component 400, such as by positioning a first wheel caster 499 at the leading edge 421 of roof portion 400c proximate to the corner of roof portion 400c that is supported by wall portion 200s-2 as roof portion 400c is deployed, as shown in FIG. 10, and positioning a similar second wheel caster 499 at the leading edge of roof portion 400c proximate to the corner of roof portion 400c that is supported by wall portion 200s-4 as roof portion 400c is deployed. Each of the wheel casters 499 comprises a wheel rotatably mounted in a frame so as to trace a linear track when displaced. Such wheel casters 499 permit the leading edge 421 of roof portion 400c in effect, to roll along the top edges 221 of transversely-oriented wall components 200 and thus facilitate unfolding. Where such wheel casters are utilized, the transverse width W₂ of roof portion 400c can be dimensioned larger than either of roof portions 400a and 400b in the transverse direction in accordance with the foregoing design alternatives, less the length “L”, shown in FIG. 10, of the first or second wheel caster 499. Further information on wheel casters 499 is found in U.S. Nonprovisional patent application Ser. No. 16/786,315, entitled “Equipment and Methods for Erecting a Transportable Foldable Building Structure,” having the same inventors as this disclosure and filed on Feb. 10, 2020, the contents of which are incorporated by reference as if fully set forth herein, particularly the description of the wheel casters 499 and their placements found for example in [symbol] 0133 and FIGS. 13D, 13E and 14B thereof.

### Enclosure Component Manufacture

For enclosure components 155 utilizing the multi-layered, laminate design disclosed herein in reference to FIG. 7, the metal sheets 206 and 217 that can be used to form first structural layer 210 and second structural layer 215 respectively can be entirely flat and juxtaposed in a simple abutting relationship. Optionally, metal sheets 206 and 217 can be provided with edge structures that facilitate placement of sheets and panels during manufacture.

Particular edge structure designs for metal sheets 206 and 217 are described in U.S. Nonprovisional patent application Ser. No. 17/504,883 entitled “Sheet/Panel Design for Enclosure Component Manufacture,” having the same inventors as the inventions described herein and filed on Oct. 19, 2021. The contents of U.S. Nonprovisional patent application Ser. No. 17/504,883 entitled “Sheet/Panel Design for Enclosure Component Manufacture,” having the same inventors as the inventions described herein and filed on Oct. 19, 2021, are incorporated by reference as if fully set forth herein, particularly including the exterior and interior edge structure designs described for example at [symbol] 00187-00205 and 00212 and in FIGS. 8, 9A-9C, 23A-23J and 24A-24B thereof.

A facility suitable for the manufacture of enclosure components 155, as well as exemplary manufacturing steps, are also described in U.S. Nonprovisional patent application Ser. No. 17/504,883 entitled “Sheet/Panel Design for Enclosure Component Manufacture,” having the same inventors as the inventions described herein and filed on Oct. 19, 2021. The contents of U.S. Nonprovisional patent application Ser. No. 17/504,883 entitled “Sheet/Panel Design for Enclosure Component Manufacture,” having the same inventors as the inventions described herein and filed on Oct. 19, 2021, are incorporated by reference as if fully set forth herein, particularly including the facility suitable for manufacturing the enclosure components 155 of the present invention, as well as exemplary manufacturing steps, described for example at [symbol] 00178-00186 and 00206-00222, and in FIGS. 22, 23A-23J and 24A-24B.

### Enclosure Component Relationships and Assembly for Transport

It is preferred that there be a specific dimensional relationship among enclosure components 155.

FIG. 2 shows a top schematic view of finished structure 150 shown in FIG. 1, and includes a geometrical orthogonal grid for clarity of explaining the preferred dimensional relationships among its enclosure components 155. The basic length used for dimensioning is indicated as “E” in FIG. 2; the orthogonal grid overlaid in FIG. 2 is 8E long and 8E wide; notably, the entire structure 150, preferably is bounded by this 8E by 8E orthogonal grid.

In FIG. 2, the four wall components 200 are each approximately 8E long, and each of roof portions 400a and 400b is approximately 8E long and 2.5E wide. Roof portion 400c is approximately 8E long and 2.9E wide. In FIGS. 2 and 3, each of floor components 300a and 300b is 8H long; whereas floor component 300a is just over 3E wide and floor component 300b is just under 5E wide.

The shipping module 100 shown edge-on in FIG. 3 includes a fixed space portion 102 defined by roof component 400a, floor component 300a, wall component 200R, wall portion 200s-1 and wall portion 200s-3. As shown in FIG. 2, fourth wall portion 200s-4 is folded inward and positioned generally against fixed space portion 102, and second wall portion 200s-2 is folded inward and positioned generally against second wall portion 200s-4 (wall portions 200s-2 and 200s-4 are respectively identified in FIG. 2 as portions 200s-2f and 200s-4f when so folded and positioned). The three roof components 400a, 400b and 400c are shown unfolded in FIG. 1 and shown accordion folded (stacked) in FIG. 3. Wall component 200P, shown in FIGS. 2 and 3, is pivotally secured to floor portion 300b at the location of axis 105, and is vertically positioned against the outside of wall portions 200s-2 and 200s-4. In turn, floor portion 300b is vertically positioned proximate fixed space portion 102, with wall component 200P pending from floor portion 300b between floor portion 300b and wall portions 200s-2 and 200s-4.

Sizing the enclosure components 155 of structure 150 according to the dimensional relationships disclosed above yields a compact shipping module 100, as can be seen from the figures. Thus shipping module 100 depicted in FIG. 3, when dimensioned according to the relationships disclosed herein using an “E” dimension (see FIG. 2) of approximately 28.625 inches (72.7 cm), and when its components are stacked and positioned as shown in FIG. 3, has an overall length of approximately 19 feet (5.79 m), an overall width of approximately 8.5 feet (2.59 meters) and an overall height of approximately 12.7 feet (3.87 meters). These overall dimensions are less than a typical shipping container.

It is preferred that the fixed space portion 102 be in a relatively finished state prior to positioning (folding) together all of the other wall, roof and floor portions as described above. In the embodiment shown in FIGS. 1 and 2, wall components 200 are fitted during manufacture and prior to shipment with all necessary door and window assemblies, with the enclosure components 155 being pre-wired, and fixed space portion 102 is fitted during manufacture with all mechanical and other functionality that structure 150 will require, such as kitchens, bathrooms, closets and other interior partitions, storage areas, etc. Carrying out the foregoing steps prior to shipment permits the builder, in effect, to erect a largely finished structure simply by “unfolding” (deploying) the positioned components of shipping module 100.

Each of the wall, floor and roof components 200, 300 and 400, and/or the portions thereof, can be sheathed in a protective film during fabrication and prior to forming the shipping module 100. Alternatively or in addition, the entire shipping module 100 can be sheathed in a protective film. Such protective films can remain in place until after the shipping module 100 is at the construction site, and then removed as required to facilitate enclosure component deployment and finishing.

### Shipping Module Transport

The shipping module is shipped to the building site by appropriate transport means. One such transport means is disclosed in U.S. Pat. No. 11,007,921, issued May 18, 2021; the contents of which are incorporated by reference as if fully set forth herein, particularly as found at column 3, line 26 to column 6, line 25 and in FIGS. 1A-2D thereof. As an alternative transport means, shipping module 100 can be shipped to the building site by means of a conventional truck trailer or a low bed trailer (also referred to as a lowboy trailer), and in the case of over-the-water shipments, by ship.

### Structure Deployment and Finishing

At the building site, shipping module 100 is positioned over its desired location, such as over a prepared foundation; for example, a poured concrete slab, a poured concrete or cinder block foundation, sleeper beams or concrete posts or columns. This can be accomplished by using a crane, either to lift shipping module 100 from its transport means and move it to the desired location, or by positioning the transport means over the desired location, lifting shipping module 100, then moving the transport means from the desired location, and then lowering shipping module 100 to a rest state at the desired location. Particularly suitable equipment and techniques for facilitating the positioning of a shipping module 100 at the desired location are disclosed in U.S. Nonprovisional patent application Ser. No. 16/786,315, entitled “Equipment and Methods for Erecting a Transportable Foldable Building Structure,” having the same inventors as this disclosure and filed on Feb. 10, 2020. The contents of that U.S. Nonprovisional patent application Ser. No. 16/786,315, entitled “Equipment and Methods for Erecting a Transportable Foldable Building Structure,” having the same inventors as this disclosure and filed on Feb. 10, 2020, are incorporated by reference as if fully set forth herein, particularly including the equipment and techniques described for example at [symbol] 00126-00128 and in connection with FIGS. 11A and 11B thereof.

Following positioning of shipping module 100 at the building site, the appropriate portions of wall, floor and roof components 200, 300 and 400 are “unfolded” (i.e., deployed) to yield structure 150. Unfolding occurs in the following sequence: (1) floor portion 300b is pivotally rotated about horizontal axis 305 (shown in FIGS. 3 and 4) to an unfolded position, (2) wall component 200P is pivotally rotated about horizontal axis 105 (indicated in FIG. 3) to an unfolded position, (3) wall portions 200s-2 and 200s-4 are pivotally rotated about vertical axes 192 and 194 (shown in FIG. 2) respectively to unfolded positions, and (4) roof portions 400b and 400c are pivotally rotated about horizontal axes 405a and 405b (shown in FIGS. 3 and 4) respectively to unfolded positions. When accordion folded as a stack, it can be appreciated that the protective layer 218 of roof portion 400a is distal from the protective layer of roof portion 400b, whereas the protective layer 218 of roof portion 400b is in contact with, or proximate to, the protective layer of roof portion 400c. Thus in unfolding roof portions 400b and 400c, it is regarded herein that the protective layer 218 of the second component portion rotates toward the protective layer 218 of the first component portion 400a, whereas the protective layer 218 of the third component portion 400c rotates away from the protective layer 218 of the second component portion 400b.

A mobile crane can be used to assist in the deployment of certain of the enclosure components 155, specifically roof portions 400b and 400c, floor portion 300b, as well as the wall component 200P pivotally secured to floor portion 300b. Alternatively, particularly suitable equipment and techniques for facilitating the deployment of enclosure components 155 are disclosed in U.S. Nonprovisional patent application Ser. No. 16/786,315, entitled “Equipment and Methods for Erecting a Transportable Foldable Building Structure,” having the same inventors as this disclosure and filed on Feb. 10, 2020. The contents of that U.S. Nonprovisional patent application Ser. No. 16/786,315, entitled “Equipment and Methods for Erecting a Transportable Foldable Building Structure,” having the same inventors as this disclosure and filed on Feb. 10, 2020, are incorporated by reference as if fully set forth herein, particularly including the equipment and techniques described for example at [symbol] 00132-00145 and depicted in FIGS. 12A-14B thereof.

After unfolding, the enclosure components 155 are secured together to finish the structure 150 that is shown in FIG. 1. If any temporary hinge structures have been utilized, then these temporary hinge structures can be removed if desired and the enclosure components 155 can be secured together. During or after unfolding and securing of the enclosure components 155, any remaining finishing operations are performed, such as addition of roofing material, and making hook-ups to electrical, fresh water and sewer lines to complete structure 150, as relevant here.

This disclosure should be understood to include (as illustrative and not limiting) the subject matter set forth in the following numbered clauses:

Clause 1. A folded building structure comprising:

a fixed space portion defined by (i) a first floor portion, (ii) a rectangular planar first roof portion having a thickness, a longitudinal length, a first transverse width and an interior surface, and (iii) a planar first fixed wall portion of a first wall component, the first fixed wall portion (x) having a first fixed portion top edge, and (y) adjoining a first transverse edge of the first floor portion and a first transverse edge of the first roof portion;

a rectangular planar second roof portion having a thickness, a longitudinal length, a second transverse width and a planar interior surface, the second roof portion horizontally stacked in a second roof portion folded position on the first roof portion and pivotally connected along a horizontal longitudinal first axis to the first roof portion to permit the second roof portion to pivot, about the first axis relative to the first roof portion, from the second roof portion folded position to a second roof portion unfolded position at which the first and second roof portions are coplanar;

a rectangular planar third roof portion having a thickness, a longitudinal length, a longitudinally-oriented leading edge, a third transverse width and an interior surface, the third transverse width being greater than the first transverse width and being greater than the second transverse width, the third roof portion horizontally stacked in a third roof portion folded position on the second roof portion and pivotally connected along a horizontal longitudinal second axis to the second roof portion to permit the third roof portion to pivot, about the second axis relative to the second roof portion, from the third roof portion folded position to a third roof portion unfolded position coplanar with the second roof portion in the second roof portion unfolded position;

the first wall component additionally including a planar first pivoting wall portion with a first pivoting portion top edge having a first pivoting portion top edge length, the first pivoting wall portion (i) disposed in a first pivoting portion folded position proximate the fixed space portion and (ii) pivotally connected along a vertical third axis to the first fixed wall portion of the first wall component to permit the first pivoting wall portion to pivot, about the third axis relative to the first fixed wall portion, from the first pivoting portion folded position to a first pivoting portion unfolded position, coplanar with the first fixed wall portion, in which the first pivoting portion top edge is positioned under the interior surfaces of the second and third roof portions when the second and third roof portions are in their unfolded positions.

Clause 2. The folded building structure of clause 1, wherein the fixed space portion is further defined by (iv) a planar second fixed wall portion of a second wall component in an opposing relationship with the first wall portion, the second fixed wall portion adjoining a second transverse edge of the first floor portion, which is opposed to the first transverse edge of the first floor portion, and adjoining a second transverse edge of the first roof portion, which is opposed to the first transverse edge of the first roof portion, with the second wall component additionally including a planar second pivoting wall portion with a second pivoting portion top edge having a second pivoting portion top edge length, the second pivoting wall portion (i) disposed in a second pivoting portion folded position proximate the fixed space portion, and (ii) pivotally connected along a vertical fourth axis to the second fixed wall portion, to permit the second pivoting wall portion to pivot, about the fourth axis relative to the second fixed wall portion of the second wall component, from the second pivoting portion folded position to a second pivoting portion unfolded position in which the second pivoting portion top edge is positioned under the interior surfaces of the second and third roof portions when the second and third roof portions are in their unfolded positions.

Clause 3. The folded building structure of either of clause 1 or clause 2, wherein the fixed space portion is further defined by (v) a third wall component having (i) a longitudinal top edge that is positioned under the interior surface of the first roof portion proximate the longitudinal edge of the first roof portion, (ii) a vertical edge that adjoins the first fixed wall portion proximate a vertical edge thereof, and (iii) a longitudinal bottom edge that adjoins the first floor portion proximate a longitudinal edge thereof.

Clause 4. The folded building structure of any one of clause 1, 2 or 3, wherein the first and second transverse widths are equal.

Clause 5. The folded building structure of any one of clause 1, 2, 3 or 4, wherein the third transverse width is greater than the second transverse width by at least the sum of the thicknesses of the first roof portion and the second roof portion.

Clause 6. The folded building structure of any one of clause 1, 2, 3, 4 or 5, wherein the third transverse width is greater than the second transverse width by an amount such that when the first pivoting wall portion is in the first pivoting portion unfolded position and the second and third roof portions are unfolded from the second and third roof portion folded positions and remain in mutual contact when so unfolded, the second and third roof portions are acutely oriented relative to the first fixed portion top edge when the leading edge of the third roof portion comes into contact with the first pivoting portion top edge.

Clause 7. The folded building structure of any one of clause 1, 2, 3, 4 or 5, further comprising a first wheel caster secured proximate the leading edge of the third roof portion at a location such that the first wheel caster comes into rolling contact with the first pivoting portion top edge for a least a portion of the first pivoting portion top edge length when the first pivoting wall portion is in the first pivoting portion unfolded position and the third roof portion is moved between the third roof portion folded position and the third roof portion unfolded position.

Clause 8. The folded building structure of clause 2, further comprising a second wheel caster secured proximate the leading edge of the third roof portion at a location such that the second wheel caster comes into rolling contact with the second pivoting portion top edge for a least a portion of the second pivoting portion top edge length when the third roof portion is moved between the third roof portion folded position and the third roof portion unfolded position.

Clause 9. The folded building structure of any one of clause 1, 2, 3 or 4, wherein the third transverse width is greater than the first transverse width by an amount in the range of from ten to fifteen percent of the first transverse width, and is greater than the second transverse width by an amount in the range of from ten to fifteen percent of the second transverse width.

Clause 10. A folded building structure comprising:

a planar first roof portion having a thickness, a first longitudinal edge, a first transverse roof edge having a width, an opposed second transverse roof edge having a width, and an interior surface, the first transverse roof edge adjoining the first longitudinal edge at a first end and the opposed second transverse roof edge adjoining the first longitudinal edge at a second end;

a planar second roof portion having a thickness, a third transverse roof edge having a width, an opposed fourth transverse roof edge having a width, and an interior surface, the second roof portion horizontally stacked in a second roof portion folded position on the first roof portion and pivotally connected along a horizontal longitudinal first axis to the first roof portion to permit the second roof portion to pivot, about the first axis relative to the first roof portion, from the second roof portion folded position to a second roof portion unfolded position at which the first and second roof portions are coplanar;

a planar third roof portion having a thickness, a longitudinally-oriented leading edge, a fifth transverse roof edge having a width, an opposed sixth transverse roof edge having a width, and an interior surface, the third roof portion horizontally stacked in a third roof portion folded position on the second roof portion and pivotally connected along a horizontal longitudinal second axis to the second roof portion to permit the third roof portion to pivot, about the second axis relative to the second roof portion, from the third roof portion folded position to a third roof portion unfolded position coplanar with the second roof portion in the second roof portion unfolded position; and

a first wall having a first vertical edge and a first transverse top edge that adjoins the first vertical edge, the first transverse top edge having a top edge length at least equal to the sum of the widths of the first, third and fifth transverse roof edges, the first roof portion joined to the first transverse top edge proximate to the first transverse roof edge with the first end proximate to the first vertical edge;

a second wall having a second vertical edge and a second transverse top edge that adjoins the second vertical edge, the second transverse top edge having a top edge length at least equal to the sum of the widths of the second, fourth and sixth transverse roof edges, the first roof portion joined to second first transverse top edge proximate to the second transverse roof edge with the second end proximate to the second vertical edge; and

wherein the width of the fifth transverse roof edge is greater than the width of the first transverse roof edge and greater than the width of the third transverse roof edge, and the width of the sixth transverse roof edge is greater than the width of the second transverse roof edge and greater than the width of the fourth transverse roof edge.

Clause 11. The folded building structure of clause 10, further comprising a third wall having a longitudinal top edge adjoining: (i) the interior surface of the first roof portion proximate the longitudinal edge of the first roof portion, (ii) the first wall proximate the first vertical edge, and (iii) the second wall proximate to the second vertical edge.

Clause 12. The folded building structure of either of clause 10 or clause 11, wherein the widths of the first and third transverse roof edges are equal to each other, and the widths of the second and fourth transverse roof edges are equal to each other.

Clause 13. The folded building structure of any one of clause 10, 11 or 12, wherein the width of the fifth transverse roof edge is greater than the width of the third transverse roof edge by at least the sum of the thicknesses of the first roof portion and the second roof portion, and the width of the sixth transverse roof edge is greater than the width of the fourth transverse roof edge by at least the sum of the thicknesses of the first roof portion and the second roof portion.

Clause 14. The folded building structure of any one of clause 10, 11, 12 or 13, wherein the width of the fifth transverse roof edge is greater than the width of the third transverse roof edge by an amount such that when the second and third roof portions are unfolded from the second and third roof portion folded positions and remain in mutual contact when so unfolded, the second and third roof portions are acutely oriented relative to the first transverse top edge and the second transverse top edge when the leading edge of the third portion comes into contact therewith.

Clause 15. The folded building structure of any one of clause 10, 11, 12 or 13, further comprising a first wheel caster secured proximate the leading edge of the third roof portion at a location such that the first wheel caster comes into rolling contact with the first transverse top edge for a least a portion of the top edge length thereof when the third roof portion is moved between the third roof portion folded position and the third roof portion unfolded position.

Clause 16. The folded building structure of clause 15, further comprising a second wheel caster secured proximate the leading edge of the third roof portion at a location such that the second wheel caster comes into rolling contact with the second transverse top edge for a least a portion of the top edge length thereof when the third roof portion is moved between the third roof portion folded position and the third roof portion unfolded position.

Clause 17. The folded building structure of any one of clause 10, 11 or 12, wherein the width of the fifth transverse roof edge is greater than the width of the first transverse roof edge and greater than the width of the third transverse roof edge by an amount in the range of from ten to fifteen percent of the width of the first transverse roof edge, and the width of the sixth transverse roof edge is greater than the width of the second transverse roof edge and greater than the width of the fourth transverse roof edge by an amount in the range of from ten to fifteen percent of the width of the second transverse roof edge.

Clause 18. A folded building structure comprising:

a planar first roof portion having a thickness, a first longitudinal edge, a first transverse roof edge having a width, an opposed second transverse roof edge having a width, and an interior surface, the first transverse roof edge adjoining the first longitudinal edge at a first end and the opposed second transverse roof edge adjoining the first longitudinal edge at a second end;

a planar second roof portion having a thickness, a third transverse roof edge having a width, an opposed fourth transverse roof edge having a width, and an interior surface, the second roof portion horizontally stacked in a second roof portion folded position on the first roof portion and pivotally connected along a horizontal longitudinal first axis to the first roof portion to permit the second roof portion to pivot, about the first axis relative to the first roof portion, from the second roof portion folded position to a second roof portion unfolded position at which the first and second roof portions are coplanar;

a planar third roof portion having a thickness, a longitudinally-oriented leading edge, a fifth transverse roof edge having a width, an opposed sixth transverse roof edge having a width, and an interior surface, the third roof portion horizontally stacked in a third roof portion folded position on the second roof portion and pivotally connected along a horizontal longitudinal second axis to the second roof portion to permit the third roof portion to pivot, about the second axis relative to the second roof portion, from the third roof portion folded position to a third roof portion unfolded position coplanar with the second roof portion in the second roof portion unfolded position; and

a first wall having a first vertical edge and a first transverse top edge that adjoins the first vertical edge, the first transverse top edge having a top edge length at least equal to the sum of the widths of the first, third and fifth transverse roof edges, the first roof portion joined to the first transverse top edge proximate to the first transverse roof edge with the first end proximate to the first vertical edge;

a second wall having a second vertical edge and a second transverse top edge that adjoins the second vertical edge, the second transverse top edge having a top edge length at least equal to the sum of the widths of the second, fourth and sixth transverse roof edges, the first roof portion joined to the second transverse top edge proximate to the second transverse roof edge with the second end proximate to the second vertical edge;

a first wheel caster having a first caster length secured proximate to the leading edge of the third roof portion at a location such that the first wheel caster comes into rolling contact with the first transverse top edge for a least a portion of the top edge length thereof when the third roof portion is moved between the third roof portion folded position and the third roof portion unfolded position; and

wherein the sum of the width of the fifth transverse roof edge and the first caster length is greater than the width of the third transverse edge by an amount such that when the second and third roof portions are unfolded from the second and third roof portion folded positions and remain in mutual contact when so unfolded, the second and third roof portions are acutely oriented relative to the first transverse top edge when the first caster comes into contact therewith.

Clause 19. The folded building structure of clause 18, wherein the widths of the first and third transverse roof edges are equal to each other, and the widths of the second and fourth transverse roof edges are equal to each other.

Clause 20. The folded building structure of either of clause 18 or clause 19, wherein the sum of the width of the fifth transverse roof edge and the first caster length is greater than the width of the third transverse roof edge by at least the sum of the thicknesses of the first roof portion and the second roof portion.

Clause 21. The folded building structure of any one of clause 18, 19 or 20, further comprising a second wheel caster having a second caster length secured proximate the leading edge of the third roof portion at a location such that the second wheel caster comes into rolling contact with the second transverse top edge for a least a portion of the top edge length thereof when the third roof portion is moved between the third roof portion folded position and the third roof portion unfolded position; and

wherein the sum of the width of the sixth transverse roof edge and the second caster length is greater than the width of the fourth transverse roof edge by an amount such that when the second and third roof portions are unfolded from the second and third roof portion folded positions and remain in mutual contact when so unfolded, the second and third roof portions are acutely oriented relative to the second transverse top edge when the second caster comes into contact therewith.

Clause 22. The folded building structure of clause 21, wherein the sum of the width of the sixth transverse roof edge and the second caster length is greater than the width of the fourth transverse roof edge by at least the sum of the thicknesses of the first roof portion and the second roof portion.

Clause 23. The folded building structure of clause 21, wherein the sum of the width of the fifth transverse roof edge and the first caster length is greater than the width of the first transverse roof edge and greater than the width of the third transverse roof edge by an amount in the range of from ten to fifteen percent of the width of the first transverse roof edge, and the sum of the width of the sixth transverse roof edge and the second caster length is greater than the width of the second transverse roof edge and greater than the width of the fourth transverse roof edge by an amount in the range of from ten to fifteen percent of the width of the second transverse roof edge.

Clause 24. The folded building structure of any one of clause 5, 13, 20 or 22, wherein each of the first, second and third roof portions comprises across its thickness:

a first structural layer having a first face and an opposing second face;

a foam panel layer having a first face and an opposing second face, the first face of the foam panel layer being bonded to the opposing second face of the first structural layer;

a second structural layer having a first face and an opposing second face, the first face of the second structural layer being bonded to the opposing second face of the foam panel layer.

Clause 25. The folded building structure of clause 24, wherein the first structural layer has a metallic composition.

Clause 26. The folded building structure of either of clause 24 or clause 25, wherein the second structural layer has a metallic composition.

Clause 27. The folded building structure of any one of clause 24, 25 or 26, further comprising a protective layer having a first face, an opposing second face, and an inorganic composition, the first face of the protective layer being bonded to the opposing second face of the second structural layer and the opposing second face of the protective layer constituting the interior surface of the roof portion.

Clause 28. The folded building structure of any one of clauses 1-27, wherein the first roof portion, the second roof portion in the second roof portion folded position, and the third roof portion in the third roof portion folded position have an accordion folded configuration.

Clause 29. The folded building structure of claim 10, wherein the width of the fifth transverse roof edge is greater than the width of the first transverse roof edge and greater than the width of the third transverse roof edge by an amount in the range of from ten to fifteen percent of the width of the third transverse roof edge, and the width of the sixth transverse roof edge is greater than the width of the second transverse roof edge and greater than the width of the fourth transverse roof edge by an amount in the range of from ten to fifteen percent of the width of the fourth transverse roof edge.

Clause 30. The folded building structure of claim 21, wherein the sum of the width of the fifth transverse roof edge and the first caster length is greater than the width of the first transverse roof edge and greater than the width of the third transverse roof edge by an amount in the range of from ten to fifteen percent of the width of the third transverse roof edge, and the sum of the width of the sixth transverse roof edge and the second caster length is greater than the width of the second transverse roof edge and greater than the width of the fourth transverse roof edge by an amount in the range of from ten to fifteen percent of the width of the fourth transverse roof edge.

What is claimed is:

1. A folded building structure comprising:
a fixed space portion defined by (i) a first floor portion, (ii) a rectangular planar first roof portion having a thickness, a longitudinal length, a first transverse width and an interior surface, and (iii) a planar first fixed wall portion of a first wall component, the first fixed wall portion (x) having a first fixed portion top edge and (y) adjoining a first transverse edge of the first floor portion and a first transverse edge of the first roof portion;
a rectangular planar second roof portion having a thickness, a longitudinal length, a second transverse width and an interior surface, the second roof portion horizontally stacked in a second roof portion folded position on the first roof portion and pivotally connected along a horizontal longitudinal first axis to the first roof portion to permit the second roof portion to pivot, about the first axis relative to the first roof portion, from the second roof portion folded position to a second roof portion unfolded position at which the first and second roof portions are coplanar;
a rectangular planar third roof portion having a thickness, a longitudinal length, a longitudinally-oriented leading edge, a third transverse width and an interior surface, the third transverse width being greater than the first transverse width and being greater than the second transverse width, the third roof portion horizontally stacked in a third roof portion folded position on the second roof portion and pivotally connected along a horizontal longitudinal second axis to the second roof portion to permit the third roof portion to pivot, about the second axis relative to the second roof portion, from the third roof portion folded position to a third roof portion unfolded position coplanar with the second roof portion in the second roof portion unfolded position;
the first wall component additionally including a planar first pivoting wall portion with a first pivoting portion top edge having a first pivoting portion top edge length, the first pivoting wall portion (i) disposed in a first pivoting portion folded position proximate the fixed space portion and (ii) pivotally connected along a vertical third axis to the first fixed wall portion of the first wall component to permit the first pivoting wall portion to pivot, about the third axis relative to the first fixed wall portion, from the first pivoting portion folded position to a first pivoting portion unfolded position, coplanar with the first fixed wall portion, in which the first pivoting portion top edge is positioned under the interior surfaces of the second and third roof portions when the second and third roof portions are in their unfolded positions.

2. The folded building structure of claim 1, wherein the fixed space portion is further defined by (iv) a planar second fixed wall portion of a second wall component in an opposing relationship with the first wall portion, the second fixed wall portion adjoining a second transverse edge of the first floor portion, which is opposed to the first transverse edge of the first floor portion, and adjoining a second transverse edge of the first roof portion, which is opposed to the first transverse edge of the first roof portion, with the second wall component additionally including a planar second pivoting wall portion with a second pivoting portion top edge having a second pivoting portion top edge length, the second pivoting wall portion (i) disposed in a second pivoting portion folded position proximate the fixed space portion, and (ii) pivotally connected along a vertical fourth axis to the second fixed wall portion, to permit the second pivoting wall portion to pivot, about the fourth axis relative to the second fixed wall portion of the second wall component, from the second pivoting portion folded position to a second pivoting portion unfolded position in which the second pivoting portion top edge is positioned under the interior surfaces of the second and third roof portions when the second and third roof portions are in their unfolded positions.

3. The folded building structure of claim 1, wherein the fixed space portion is further defined by (v) a third wall component having (i) a longitudinal top edge that is positioned under the interior surface of the first roof portion proximate the longitudinal edge of the first roof portion, (ii) a vertical edge that adjoins the first fixed wall portion proximate a vertical edge thereof, and (iii) a longitudinal bottom edge that adjoins the first floor portion proximate a longitudinal edge thereof.

4. The folded building structure of claim 1, wherein the first and second transverse widths are equal.

5. The folded building structure of claim 1, wherein the third transverse width is greater than the second transverse width by at least the sum of the thicknesses of the first roof portion and the second roof portion.

6. The folded building structure of claim 1, wherein the third transverse width is greater than the second transverse width by an amount such that when the first pivoting wall portion is in the first pivoting portion unfolded position and the second and third roof portions are unfolded from the second and third roof portion folded positions and remain in mutual contact when so unfolded, the second and third roof portions are acutely oriented relative to the first fixed portion top edge when the leading edge of the third roof portion comes into contact with the first pivoting portion top edge.

7. The folded building structure of claim 1, further comprising a first wheel caster secured proximate the leading edge of the third roof portion at a location such that the first wheel caster comes into rolling contact with the first pivoting portion top edge for a least a portion of the first pivoting portion top edge length when the first pivoting wall portion is in the first pivoting portion unfolded position and the third roof portion is moved between the third roof portion folded position and the third roof portion unfolded position.

8. The folded building structure of claim 2, further comprising a second wheel caster secured proximate the leading edge of the third roof portion at a location such that the second wheel caster comes into rolling contact with the second pivoting portion top edge for a least a portion of the second pivoting portion top edge length when the third roof portion is moved between the third roof portion folded position and the third roof portion unfolded position.

9. The folded building structure of claim 1, wherein the third transverse width is greater than the first transverse width by an amount in the range of from ten to fifteen percent of the first transverse width, and is greater than the second transverse width by an amount in the range of from ten to fifteen percent of the second transverse width.

10. A folded building structure comprising:
a planar first roof portion having a thickness, a first longitudinal edge, a first transverse roof edge having a width, an opposed second transverse roof edge having a width, and an interior surface, the first transverse roof edge adjoining the first longitudinal edge at a first end and the opposed second transverse roof edge adjoining the first longitudinal edge at a second end;
a planar second roof portion having a thickness, a third transverse roof edge having a width, an opposed fourth transverse roof edge having a width, and an interior surface, the second roof portion horizontally stacked in a second roof portion folded position on the first roof portion and pivotally connected along a horizontal longitudinal first axis to the first roof portion to permit the second roof portion to pivot, about the first axis relative to the first roof portion, from the second roof portion folded position to a second roof portion unfolded position at which the first and second roof portions are coplanar;
a planar third roof portion having a thickness, a longitudinally-oriented leading edge, a fifth transverse roof edge having a width, an opposed sixth transverse roof edge having a width, and an interior surface, the third roof portion horizontally stacked in a third roof portion folded position on the second roof portion and pivotally connected along a horizontal longitudinal second axis to the second roof portion to permit the third roof portion to pivot, about the second axis relative to the second roof portion, from the third roof portion folded position to a third roof portion unfolded position coplanar with the second roof portion in the second roof portion unfolded position; and
a first wall having a first vertical edge and a first transverse top edge that adjoins the first vertical edge, the first transverse top edge having a top edge length at least equal to the sum of the widths of the first, third and fifth transverse roof edges, the first roof portion joined to the first transverse top edge proximate to the first transverse roof edge with the first end proximate to the first vertical edge;
a second wall having a second vertical edge and a second transverse top edge that adjoins the second vertical edge, the second transverse top edge having a top edge length at least equal to the sum of the widths of the second, fourth and sixth transverse roof edges, the first roof portion joined to the second transverse top edge proximate to the second transverse roof edge with the second end proximate to the second vertical edge; and
wherein the width of the fifth transverse roof edge is greater than the width of the first transverse roof edge and greater than the width of the third transverse roof edge, and the width of the sixth transverse roof edge is greater than the width of the second transverse roof edge and greater than the width of the fourth transverse roof edge.

11. The folded building structure of claim 10, further comprising a third wall having a longitudinal top edge adjoining: (i) the interior surface of the first roof portion proximate the longitudinal edge of the first roof portion, (ii) the first wall proximate the first vertical edge, and (iii) the second wall proximate to the second vertical edge.

12. The folded building structure of claim 10, wherein the widths of the first and third transverse roof edges are equal to each other, and the widths of the second and fourth transverse roof edges are equal to each other.

13. The folded building structure of claim 10, wherein the width of the fifth transverse roof edge is greater than the width of the third transverse roof edge by at least the sum of the thicknesses of the first roof portion and the second roof portion, and the width of the sixth transverse roof edge is greater than the width of the fourth transverse roof edge by at least the sum of the thicknesses of the first roof portion and the second roof portion.

14. The folded building structure of claim 10, wherein the width of the fifth transverse roof edge is greater than the width of the third transverse roof edge by an amount such that when the second and third roof portions are unfolded from the second and third roof portion folded positions and remain in mutual contact when so unfolded, the second and third roof portions are acutely oriented relative to the first transverse top edge and the second transverse top edge when the leading edge of the third portion comes into contact therewith.

15. The folded building structure of claim 10, further comprising a first wheel caster secured proximate the leading edge of the third roof portion at a location such that the first wheel caster comes into rolling contact with the first transverse top edge for a least a portion of the top edge length thereof when the third roof portion is moved between the third roof portion folded position and the third roof portion unfolded position.

16. The folded building structure of claim 15, further comprising a second wheel caster secured proximate the leading edge of the third roof portion at a location such that the second wheel caster comes into rolling contact with the second transverse top edge for a least a portion of the top edge length thereof when the third roof portion is moved between the third roof portion folded position and the third roof portion unfolded position.

17. The folded building structure of claim 10, wherein the width of the fifth transverse roof edge is greater than the width of the first transverse roof edge and greater than the width of the third transverse roof edge by an amount in the range of from ten to fifteen percent of the width of the first transverse roof edge, and the width of the sixth transverse roof edge is greater than the width of the second transverse roof edge and greater than the width of the fourth transverse roof edge by an amount in the range of from ten to fifteen percent of the width of the second transverse roof edge.

18. A folded building structure comprising:
a planar first roof portion having a thickness, a first longitudinal edge, a first transverse roof edge having a width, an opposed second transverse roof edge having a width, and an interior surface, the first transverse roof edge adjoining the first longitudinal edge at a first end and the opposed second transverse roof edge adjoining the first longitudinal edge at a second end;
a planar second roof portion having a thickness, a third transverse roof edge having a width, an opposed fourth transverse roof edge having a width, and an interior surface, the second roof portion horizontally stacked in a second roof portion folded position on the first roof portion and pivotally connected along a horizontal longitudinal first axis to the first roof portion to permit the second roof portion to pivot, about the first axis relative to the first roof portion, from the second roof portion folded position to a second roof portion unfolded position at which the first and second roof portions are coplanar;
a planar third roof portion having a thickness, a longitudinally-oriented leading edge, a fifth transverse roof edge having a width, an opposed sixth transverse roof edge having a width, and an interior surface, the third roof portion horizontally stacked in a third roof portion folded position on the second roof portion and pivotally connected along a horizontal longitudinal second axis to the second roof portion to permit the third roof portion to pivot, about the second axis relative to the second roof portion, from the third roof portion folded position to a third roof portion unfolded position coplanar with the second roof portion in the second roof portion unfolded position; and
a first wall having a first vertical edge and a first transverse top edge that adjoins the first vertical edge, the first transverse top edge having a top edge length at least equal to the sum of the widths of the first, third and fifth transverse roof edges, the first roof portion joined to the first transverse top edge proximate to the first transverse roof edge with the first end proximate to the first vertical edge;
a second wall having a second vertical edge and a second transverse top edge that adjoins the second vertical edge, the second transverse top edge having a top edge length at least equal to the sum of the widths of the second, fourth and sixth transverse roof edges, the first roof portion joined to the second transverse top edge proximate to the second transverse roof edge with the second end proximate to the second vertical edge;
a first wheel caster having a first caster length secured proximate to the leading edge of the third roof portion at a location such that the first wheel caster comes into rolling contact with the first transverse top edge for a least a portion of the top edge length thereof when the third roof portion is moved between the third roof portion folded position and the third roof portion unfolded position; and
wherein the sum of the width of the fifth transverse roof edge and the first caster length is greater than the width of the third transverse edge by an amount such that when the second and third roof portions are unfolded from the second and third roof portion folded positions and remain in mutual contact when so unfolded, the second and third roof portions are acutely oriented relative to the first transverse top edge when the first caster comes into contact therewith.

19. The folded building structure of claim 18, wherein the widths of the first and third transverse roof edges are equal to each other, and the widths of the second and fourth transverse roof edges are equal to each other.

20. The folded building structure of claim 18, wherein the sum of the width of the fifth transverse roof edge and the first caster length is greater than the width of the third transverse roof edge by at least the sum of the thicknesses of the first roof portion and the second roof portion.

21. The folded building structure of claim 18, further comprising a second wheel caster having a second caster length secured proximate the leading edge of the third roof portion at a location such that the second wheel caster comes into rolling contact with the second transverse top edge for a least a portion of the top edge length thereof when the third roof portion is moved between the third roof portion folded position and the third roof portion unfolded position; and
wherein the sum of the width of the sixth transverse roof edge and the second caster length is greater than the width of the fourth transverse roof edge by an amount such that when the second and third roof portions are unfolded from the second and third roof portion folded positions and remain in mutual contact when so unfolded, the second and third roof portions are acutely oriented relative to the second transverse top edge when the second caster comes into contact therewith.

22. The folded building structure of claim 21, wherein the sum of the width of the sixth transverse roof edge and the second caster length is greater than the width of the fourth transverse roof edge by at least the sum of the thicknesses of the first roof portion and the second roof portion.

23. The folded building structure of claim 21, wherein the sum of the width of the fifth transverse roof edge and the first caster length is greater than the width of the first transverse roof edge and greater than the width of the third transverse roof edge by an amount in the range of from ten to fifteen percent of the width of the first transverse roof edge, and the sum of the width of the sixth transverse roof edge and the second caster length is greater than the width of the second transverse roof edge and greater than the width of the fourth transverse roof edge by an amount in the range of from ten to fifteen percent of the width of the second transverse roof edge.
